(19) United States
(12) Patent Application Publication
(10) Pub. No.: US 2022/0406126 A1
(43) Pub. Date: Dec. 22, 2022

(54) GAMING MACHINE AND METHOD

(71) Applicant: Ainsworth Game Technology Limited, Newington (AU)

(72) Inventor: Pairatch Paotrukal, Panania (AU)

(21) Appl. No.: 17/807,231

(22) Filed: Jun. 16, 2022

(30) Foreign Application Priority Data
Jun. 18, 2021 (AU) 2021204096

(51) Int. Cl. G07F 17/32; G07F 17/34

(52) U.S. Cl. CPC G07F 17/3223; G07F 17/3213; G07F 17/34

(57) ABSTRACT

A gaming machine comprises a display for playing a game and an electronic controller coupled to the display to control the display of game symbols on the display. The game comprises randomly selected game symbols displayed in a set of reels, where predetermined winning combinations of the randomly selected game symbols in the game award prizes to a player. The appearance of a predetermined number of special symbols and at least one activator symbol results in the special symbols and at least one activator symbol being kept in position while the remaining positions in the reels are respun. Game enhancing elements associated with the special symbols are awarded to the player.

### BACKGROUND

The present disclosure relates to a gaming machine and method. The present disclosure has been developed primarily for use as an electronic gaming machine and will be described hereinafter by reference to this application. However, it will be appreciated that the present disclosure may also be implemented for any type of gaming machine, including a mechanical or electro-mechanical gaming machine.

The following discussion of the prior art is intended to present the present disclosure in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

One type of gaming machine comprises a mechanical or electro-mechanical device, where a motor rotates a plurality of annular rings or drums that form reels. Each reel has a reel strip that displays game symbols in preset game symbol positions. A frame covers the rings to provide a window through which only a subset of game symbol positions (and hence game symbols) were visible to the player. Thus, for a game using a 5×3 array, the window would only permit three rows of five rings to be visible to create the game array. An internal electronic controller within the gaming machine controls operation of the motor and hence rotation of the reels. Thus, by controlling when each reel starts and stops in its respective rotation, the electronic controller controls the display of the game symbols in the window. Sensors linked to the reels indicate which game symbols are displayed in the window and communicate with the electronic controller so that the electronic controller is able to award prizes based on winning combinations of game symbols displayed on the reels in the window. The electronic controller typically comprises one or more electric circuits for controlling various functions of the gaming machine, such as the above mentioned control of the motor, communicating with the sensors, verifying that the correct amount of a bet has been made via one or more value receiving mechanisms to enable operation of the motors, controlling any visual and/or audio effects associated with operation of the gaming machine and controlling operation of various alarms to alert any tampering with the gaming machine.

Another type of gaming machine, known as an electronic gaming machine or EGM, replaces the mechanical reels and motor with a video display screen on which video images of the reels are displayed. The EGM has an internal electronic game controller, typically a computer, that controls the display of images on the video display screen so that the reels are visibly spun on the screen to simulate a physical reel of a traditional gaming machine. EGMs tend to be more versatile in providing game information, varying the probabilities for a player to win a prize and varying the type of game that is played.

Bonus or “feature” games may also be provided by a gaming machine in addition to a base or main game. Typically feature games use the same set of reels as the main game and are limited to a set of free games operated under a single set of rules. This means that the feature game is restricted by the same set of rules, and so there is no variation in the play of the feature game. Also, gaming machines can offer one or more bonus prizes to the player during play of the game. The most common type of bonus prize that is awarded by the gaming machine is a jackpot prize, the main example of which is a progressive jackpot prize.

This standard structure to game play and bonus prizes limits the operation of the gaming machine, irrespective of whether it is a mechanical, electro-mechanical or electronic gaming machine. Consequently, it is difficult to retain player interest because there is no apparent incentive for the player to continue playing the gaming machine once the player becomes familiar with the feature game, the main game and any bonus prizes.

It is an object of the present disclosure to overcome or substantially ameliorate one or more of the disadvantages of prior art, or at least to provide a useful alternative.

### SUMMARY

The present disclosure provides a gaming machine that has improved operation and performance relative to existing prior art gaming machines by providing a more efficient way of awarding prizes to a player of the gaming machine and/or optimising the use of screen space for the gaming machine compared to presently existing gaming machines. The present disclosure also improves the application of an electronic controller in playing the game on the gaming machine.

One embodiment of the present disclosure provides a gaming machine comprising a display for displaying a game, wherein the game comprises randomly selected game symbols displayed in an array of game positions, and where predetermined winning combinations of the randomly selected game symbols in the game award prizes to a player; and a game controller coupled to the display for controlling the display of the game symbols on the display; wherein the controller is configured to: randomly select game symbols in a first play of the game, wherein the game symbols are selected from a set of game symbols, including a special symbol and an activator symbol; associate a game enhancing element with each selected special symbol; and display the randomly selected game symbols in the game positions. In response to a predetermined number of the special symbols and at least one activator symbol being displayed in the first play, for one or more subsequent plays of the game, the game controller is configured to: display the special symbols and the at least one activator symbol in the same game positions; randomly select game symbols from the set of game symbols; display the randomly selected game symbols in game positions not occupied by the special symbols or the at least one activator symbol; determine if additional special symbols or activator symbols are displayed in the array; award the game enhancing elements associated with the displayed special symbols; and display the additional special symbols and activator symbols in the same game positions in the next play of the game.

Another embodiment of the present disclosure provides a gaming machine comprising: a display for displaying a first game, wherein the game comprises randomly selected game symbols displayed in an array of game positions, and where predetermined winning combinations of the randomly selected game symbols in the game award prizes to a player; and a game controller coupled to the display for controlling the display of the game symbols on the display; wherein the game controller is configured to: randomly select game symbols in a play of the first game, wherein the game symbols are selected from a set of game symbols, including a special symbol and an activator symbol; associate a game enhancing element with each selected special symbol; display the randomly selected game symbols in the game positions; and in response to a predetermined number of special symbols and at least one activator symbol being displayed in the play of the first game, triggering a second game. For each play of the second game, the game controller is configured to: display the special symbols and the at least one activator symbol in the same game positions; randomly select game symbols from the set of game symbols; display the randomly selected game symbols in game positions not occupied by the special symbols or the at least one activator symbol; determine if additional special symbols or activator symbols are displayed in the array; award the game enhancing elements associated with the displayed special symbols; and display the additional special symbols and activator symbols in the same game positions in the next play of the game.

Another embodiment of the present disclosure provides a gaming machine comprising: a display for displaying a game; a controller for controlling the display of the game symbols on the display; and a value transfer mechanism for receiving value from the player, wherein the controller is in communication with the value transfer mechanism and the value transfer mechanism comprises at least one of a coin acceptor and a paper currency acceptor. The controller is configured to: determine if a wager has been received via the value transfer mechanism; display a play of the game on the display including one or more configurations of game symbols if the wager has been received, one or more of the configurations of game symbols being associated with a game outcome, the game outcome being associated with a value award payable to a player; provide an array of game positions in which to display the one or more configurations of game symbols; the game positions being arranged into one or more groups; wherein the controller is configured to: randomly select game symbols in a first play of the game, wherein the game symbols are selected from a set of game symbols, including a special symbol and an activator symbol; associate a game enhancing element with each selected special symbol; and display the randomly selected game symbols in the game positions. In response to a predetermined number of the special symbols and at least one activator symbol being displayed in the first play, for one or more subsequent plays of the game, the game controller is configured to: display the special symbols and the at least one activator symbol in the same game positions; randomly select game symbols from the set of game symbols; display the randomly selected game symbols in game positions not occupied by the special symbols or the at least one activator symbol; determine if additional special symbols or activator symbols are displayed in the array; award the game enhancing elements associated with the displayed special symbols; and display the additional special symbols and activator symbols in the same game positions in the next play of the game.

Yet another embodiment of the present disclosure provides a gaming machine comprising: at least one video display for displaying a game; a value input comprising at least one of a coin acceptor, a bill acceptor and a ticket reader; and at least one electronic controller coupled to the at least one video display and the value input. The controller is configured to: determine if a wager has been received via the value input; display the game on the display including one or more configurations of game symbols if the wager has been received, one or more of the configurations of game symbols being associated with a game outcome, the game outcome being associated with a value award payable to a player; provide a plurality of reels comprising game positions for displaying game symbols and the one or more configurations of game symbols; wherein the controller is configured to: randomly select game symbols in a first play of the game, wherein the game symbols are selected from a set of game symbols, including a special symbol and an activator symbol; associate a game enhancing element with each selected special symbol; and display the randomly selected game symbols in the game positions. In response to a predetermined number of the special symbols and at least one activator symbol being displayed in the first play, for one or more subsequent plays of the game, the game controller is configured to: display the special symbols and the at least one activator symbol in the same game positions; randomly select game symbols from the set of game symbols; display the randomly selected game symbols in game positions not occupied by the special symbols or the at least one activator symbol; determine if additional special symbols or activator symbols are displayed in the array; award the game enhancing elements associated with the displayed special symbols; and display the additional special symbols and activator symbols in the same game positions in the next play of the game.

An additional embodiment of the present disclosure provides a gaming machine comprising a display for displaying a game, wherein the game comprises randomly selected game symbols displayed in an array of game positions, and where predetermined winning combinations of the randomly selected game symbols in the game award prizes to a player; a game controller for controlling the display of the game symbols on the display, the game controller comprising a processor for executing program instructions stored on a memory to operate the game; a random number generator to randomly select the game symbols; a metering module for monitoring the credits available to play the gaming machine and the amount of any wins made by the player; a value transfer mechanism for receiving value from the player, wherein the value transfer mechanism comprises at least one of a coin slot or acceptor, a paper currency acceptor, a ticket reader and/or printer or a card reader and/or writer; and a plurality of buttons in communication with the game controller to receive and transmit player commands to the game controller to play the game; wherein the game controller is in communication with the value transfer mechanism and the metering module such that when a threshold amount of value has been received from the value transfer mechanism, the game controller initiates a play of the game; wherein the game controller is configured to: randomly select game symbols in a first play of the game, wherein the game symbols are selected from a set of game symbols, including a special symbol and an activator symbol; associate a game enhancing element with each selected special symbol; and display the randomly selected game symbols in the game positions. In response to a predetermined number of the special symbols and at least one activator symbol being displayed in the first play, for one or more subsequent plays of the game, the game controller is configured to: display the special symbols and the at least one activator symbol in the same game positions; randomly select game symbols from the set of game symbols; display the randomly selected game symbols in game positions not occupied by the special symbols or the at least one activator symbol; determine if additional special symbols or activator symbols are displayed in the array; award the game enhancing elements associated with the displayed special symbols; and display the additional special symbols and activator symbols in the same game positions in the next play of the game.

An additional embodiment of the present disclosure provides a gaming machine comprising a display for displaying a first game, wherein the first game comprises randomly selected game symbols displayed in an array of game positions, and where predetermined winning combinations of the randomly selected game symbols in the game award prizes to a player; a game controller for controlling the display of the game symbols on the display, the game controller comprising a processor for executing program instructions stored on a memory to operate the game; a random number generator to randomly select the game symbols; a metering module for monitoring the credits available to play the gaming machine and the amount of any wins made by the player; a value transfer mechanism for receiving value from the player, wherein the value transfer mechanism comprises at least one of a coin slot or acceptor, a paper currency acceptor, a ticket reader and/or printer or a card reader and/or writer; and a plurality of buttons in communication with the game controller to receive and transmit player commands to the game controller to play the game; wherein the game controller is in communication with the value transfer mechanism and the metering module such that when a threshold amount of value has been received from the value transfer mechanism, the game controller initiates a play of the first game; wherein the game controller is configured to: randomly select game symbols in the play of the first game, wherein the game symbols are selected from a set of game symbols, including a special symbol and an activator symbol; associate a game enhancing element with each selected special symbol; and display the randomly selected game symbols in the game positions. In response to a predetermined number of the special symbols and at least one activator symbol being displayed in the play of the first game, triggering a second game. For each play of the second game, the game controller is configured to: display the special symbols and the at least one activator symbol in the same game positions; randomly select game symbols from the set of game symbols; display the randomly selected game symbols in game positions not occupied by the special symbols or the at least one activator symbol; determine if additional special symbols or activator symbols are displayed in the array; award the game enhancing elements associated with the displayed special symbols; and display the additional special symbols and activator symbols in the same game positions in the next play of the second game.

A further embodiment of the present disclosure provides a gaming method comprising displaying game symbols for playing a game, wherein the game comprises game symbols and predetermined winning combinations of randomly selected game symbols award prizes to a player; providing an array of game positions to display game symbols, the method comprising: randomly selecting game symbols in a first play of the game, wherein the game symbols are selected from a set of game symbols, including a special symbol and an activator symbol; associating a game enhancing element with each selected special symbol; and displaying the randomly selected game symbols in the game positions. In response to a predetermined number of the special symbols and at least one activator symbol being displayed in the first play, for one or more subsequent plays of the game, the method comprises displaying the special symbols and the at least one activator symbol in the same game positions; randomly selecting game symbols from the set of game symbols; displaying the randomly selected game symbols in game positions not occupied by the special symbols or the at least one activator symbol; determining if additional special symbols or activator symbols are displayed in the array; awarding the game enhancing elements associated with the displayed special symbols; and displaying the additional special symbols and activator symbols in the same game positions in the next play of the game.

A still further embodiment of the present disclosure provides a method of operating a gaming machine comprising a display for displaying a game, wherein the game comprises randomly selected game symbols displayed in an array of game positions, and where predetermined winning combinations of the randomly selected game symbols in the game award prizes to a player; a game controller for controlling the display of the game symbols on the display, the game controller comprising a processor for executing program instructions stored on a memory to operate the game; a random number generator to randomly select the game symbols; a metering module for monitoring the credits available to play the gaming machine and the amount of any wins made by the player; a value transfer mechanism for receiving value from the player, wherein the value transfer mechanism comprises at least one of a coin slot or acceptor, a paper currency acceptor, a ticket reader and/or printer or a card reader and/or writer; and a plurality of buttons in communication with the game controller to receive and transmit player commands to the game controller to play the game; the method comprising randomly selecting game symbols in a first play of the game, wherein the game symbols are selected from a set of game symbols, including a special symbol and an activator symbol; associating a game enhancing element with each selected special symbol; and displaying the randomly selected game symbols in the game positions. In response to a predetermined number of the special symbols and at least one activator symbol being displayed in the first play, for one or more subsequent plays of the game, the method comprises displaying the special symbols and the at least one activator symbol in the same game positions; randomly selecting game symbols from the set of game symbols; displaying the randomly selected game symbols in game positions not occupied by the special symbols or the at least one activator symbol; determining if additional special symbols or activator symbols are displayed in the array; awarding the game enhancing elements associated with the displayed special symbols; and displaying the additional special symbols and activator symbols in the same game positions in the next play of the game.

A further embodiment provides a computer system comprising a central processing unit configured for communication with a gaming machine, wherein the computer system is configured to perform the method of any one of the above described embodiments of the present disclosure.

A further embodiment provides a computer program configured to perform the method of any one of the above described embodiments of the present disclosure.

A further embodiment provides a non-transitory carrier medium carrying computer executable code that, when executed on a central processing unit configured for communication with a gaming machine, causes the central processing unit to perform the method of any one of the above described embodiments of the present disclosure.

Throughout the specification and unless explicitly stated otherwise, the term “value” means credits, gaming tokens, coins, paper, currency, tickets, vouchers, credit cards, debit cards, smart cards, memory devices capable of storing value and any other object representative of value.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

The disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is a perspective view of a gaming machine according to a first embodiment of the present disclosure.

FIGS. 2A and 2B are schematic drawings of an electronic controller for the gaming machine of FIG. 1.

FIG. 3 is a simulated screen shot of a base game shown on the display of the gaming machine of FIG. 1.

FIG. 4 is a simulated screen shot of a base game according to another embodiment of the disclosure shown on the display of the gaming machine of FIG. 1.

FIGS. 5 to 8 are simulated screen shots of a feature game according to another embodiment of the disclosure shown on the display of the gaming machine of FIG. 1.

FIGS. 9 and 10 are simulated screen shots of a feature game according to a further embodiment of the disclosure shown on the display of the gaming machine of FIG. 1.

FIGS. 11 to 13 are simulated screen shots of a feature game according to a still further embodiment of the disclosure shown on the display of the gaming machine of FIG. 1.

FIG. 14 is a perspective view of an electronic gaming machine according to yet another embodiment of the present disclosure.

FIG. 15 is a schematic drawing of a control panel for the electronic gaming machine of FIG. 14.

FIG. 16 is a block diagram of the electronic components of the electronic gaming machine of FIG. 14.

### DETAILED DESCRIPTION OF VARIOUS EMBODIMENTS

The present disclosure will now be described with reference to the following examples which should be considered in all respects as illustrative and non-restrictive. In the Figures, corresponding features within the same embodiment or common to different embodiments have been given the same reference numerals.

In general terms, a gaming machine according to the embodiments described herein includes at least one display, and an electronic controller coupled to the at least one display. In some embodiments, the gaming machine comprises a value transfer mechanism or a value input that is coupled to the electronic controller.

The electronic controller is configured to randomly select game symbols in a first play of the game, wherein the game symbols are selected from a set of game symbols, including a special symbol and an activator symbol; associate a game enhancing element with each selected special symbol; and display the randomly selected game symbols in the game positions. In response to a predetermined number of the special symbols and at least one activator symbol being displayed in the first play, for one or more subsequent plays of the game, the game controller is configured to: display the special symbols and the at least one activator symbol in the same game positions; randomly select game symbols from the set of game symbols; display the randomly selected game symbols in game positions not occupied by the special symbols or the at least one activator symbol; determine if additional special symbols or activator symbols are displayed in the array; award the game enhancing elements associated with the displayed special symbols; and display the additional special symbols and activator symbols in the same game positions in the next play of the game.

In some embodiments, the game enhancing element is randomly associated with each special symbol.

In some embodiments, the game enhancing element associated with one or more special symbols comprises a credit prize. In one embodiment, the amount of the credit prize is randomly selected for each special symbol. In another embodiment, the amount of the credit prize increases for each game position that is occupied by the special symbol.

In some embodiments, the game enhancing element associated with at least one special symbol comprises a jackpot prize. In one embodiment, the amount of the jackpot prize is randomly selected for the at least one special symbol.

In some embodiments, the game enhancing element is immediately awarded to the player during the game. In other embodiments, the game enhancing element is immediately awarded to the player at the end of the game.

In some embodiments, the activator symbol is associated with a multiplier value that multiplies the amount of prizes awarded in the game. In other embodiments, the number of activator symbols are counted at the end of the game and the amount of a prize awarded is multiplied by the number of activator symbols counted.

In some embodiments, the activator symbol causes the game enhancing elements associated with the displayed special symbols to be awarded again in the same play. In other embodiments, the game enhancing elements associated with the displayed special symbols are awarded again in the same play for each activator symbol displayed in the array.

In some embodiments, a predetermined number of activator symbols appearing in the array causes the game controller to reset the number of plays remaining in the game. In other embodiments, a predetermined number of trigger symbols appearing in the array causes the controller to reset the number of plays remaining in the game. Preferably, the trigger symbols are associated with a credit prize.

In some embodiments, the predetermined number of special symbols is three. In other embodiments, the predetermined number of special symbols may range from one to ten.

In some embodiments, a threshold number of special symbols in one play of the game causes the game controller to display the special symbols in the same game positions in another play of the game; randomly select game symbols from the set of game symbols; display the randomly selected game symbols in game positions not occupied by the special symbols; determine if the activator symbol is displayed in the array; and determine if there is the predetermined number of special symbols and the at least one activator symbol displayed.

In some embodiments, a threshold number of special symbols in one play of the first game causes the game controller to trigger a third game, wherein the game controller is configured to hold the special symbols in their respective game positions from the one play, randomly select game symbols from the set of game symbols; display the randomly selected game symbols in game positions not occupied by the held special symbols; determine if the activator symbol is displayed in the array; and determine if there is the predetermined number of special symbols and the at least one activator symbol displayed.

In some embodiments, the threshold number of special symbols is the same as the predetermined number. In other embodiments, the threshold number is different to the predetermined number. In further embodiments, the threshold number of special symbols may range from one to ten, but is preferably six.

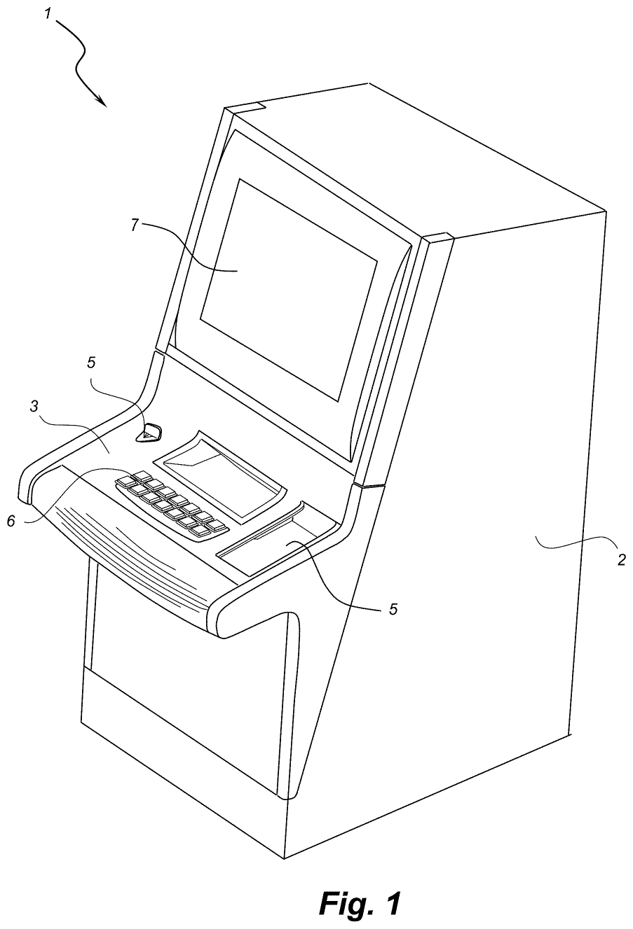

Referring to FIG. 1, a gaming machine 1 according to a first embodiment includes a cabinet 2, a console 3 and an internal electronic controller 4. The console 3 has various input devices including value inputs, such as vending slots 5 for receiving monetary bets, and a plurality of buttons 6 for actuation by a player. It will be appreciated that in other embodiments the vending slots 5 may be replaced with other types of value input/value output devices, such as a coin acceptor, a paper currency acceptor, a ticket reader and/or printer or a card reader and/or writer.

The vending slots 5 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the gaming machine 1. Other forms of value include gaming tokens, paper, tickets, vouchers, and any other object representative of value.

In this embodiment, the buttons 6 are physical buttons provided on the console 3. However, it will be appreciated that the buttons 6 can be replaced with virtual buttons on the display 7 that are touch sensitive surfaces for receiving commands from the player, the touch sensitive surfaces or virtual buttons being in electronic communication with the controller 4 to transmit the player commands. Alternatively, there may be a combination of buttons 6 on the console 3 and touch sensitive surfaces or virtual buttons on the display 7.

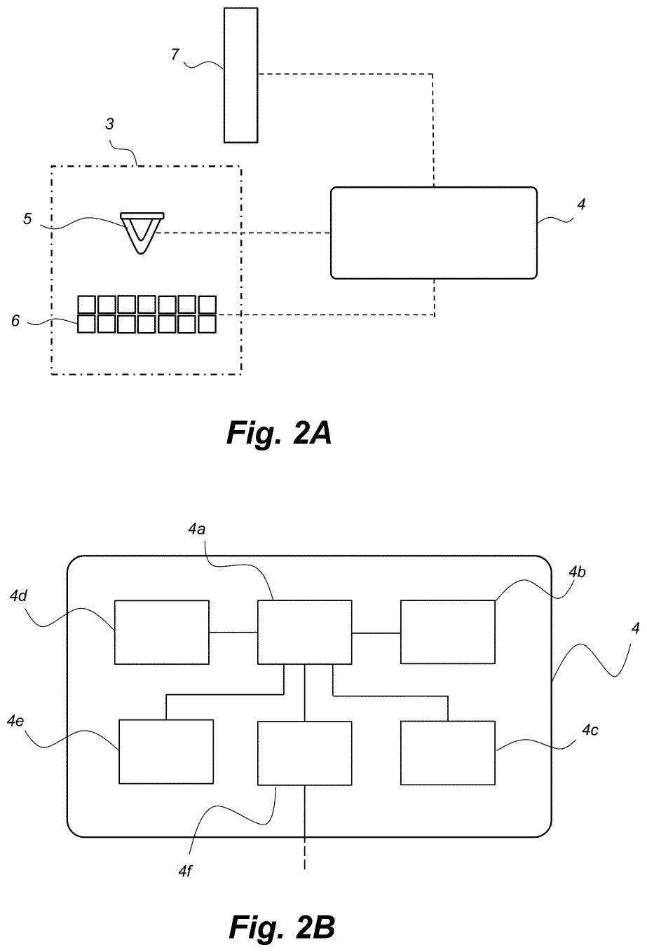

The controller 4 is generally in the form of an electronic controller comprising a central processing unit or processor, such as a computer, and is in electronic communication with a display in the form of a video display screen 7, as well as the various input devices on the console 3, as best shown in FIG. 2A. Typically, the electronic controller 4 also comprises a processor 4a, a random access memory (RAM) 4b and a further storage memory 4c, the RAM and storage memory being operatively associated with the processor 4a. See FIG. 2B. The RAM 4b is used to store program instructions and transient data related to the operation of the electronic controller and hence the gaming machine 1. The RAM 4b contains a body of program instructions for implementing a game on the gaming machine 1, as discussed in more detail below. The further storage memory 4c, which may take the form of a hard disk drive, is used for long-term storage of program components and data relating to the electronic controller 4 and/or the gaming machine 1, including firmware, a database for game performance data, as well as information gathered from users.

The electronic game controller 4 may also comprise modules to assist in exercising functions in relation to the operation of the gaming machine 1, including a metering module 4d for monitoring operation of the gaming machine in compliance with regulatory requirements, the amount of player credit; the credits available to play the gaming machine and/or amount of any wins made by the player; a random number generator 4e for enabling the game controller to make random decisions, as may be required from time to time by the gaming machine to implement a game (such as randomly selecting game symbols to be displayed in the game); and an input/output interface 4f for communicating with peripheral devices, including input devices like the value transfer mechanism 5 and buttons 6. It is also appreciated that a person skilled in the art would readily understand the location and use of the electronic controller 4 in the gaming machine 1.

The electronic game controller 4 will transmit and receive signals to and from each of the input devices and the display 7, usually via wired connections but can include wireless modes of electronic communication, such as WLAN. In the case of the vending slots 5 (or with any other type of value transfer mechanism), there may be an intermediate credit verification device that examines and verifies the cash or credits received by the vending slots. Once the value (such as cash or credits) have been verified by the credit verification device, a signal is sent to the electronic game controller 4, which then determines whether the minimum bet level has been reached. If so, the electronic game controller 4 will permits play of the game on the gaming machine 1. If not, the electronic game controller 4 will send a signal to the display 7 to show a message requesting further value to be added to the gaming machine 1.

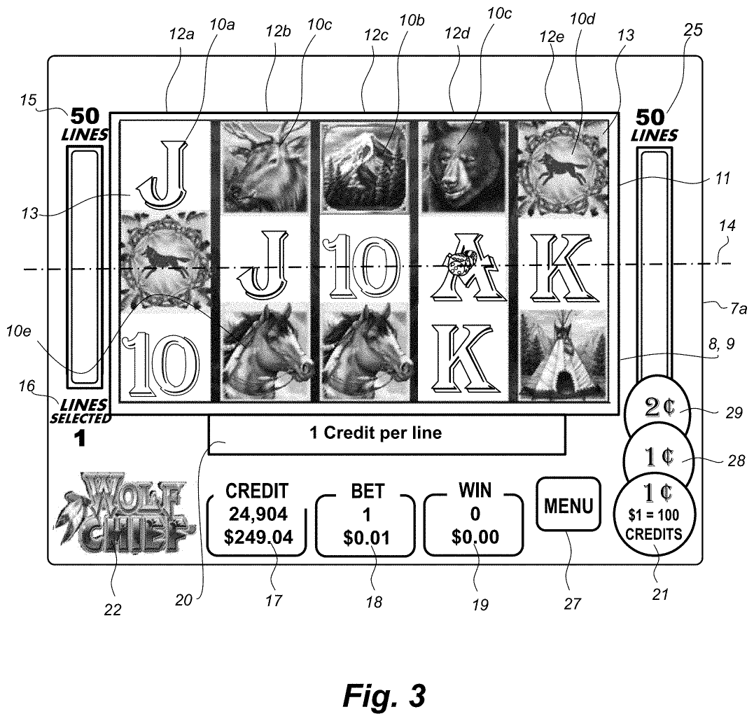

The electronic game controller 4 is programmed to provide a game in the form of a base game 8 (as best shown in FIG. 3) and a feature game 9 on a lower playing area 7a of the display 7 of the gaming machine 1 for play by a player. An upper display area (not shown) is reserved for showing artwork associated with the game(s) that are available for play on the gaming machine and/or other game information. The base game 8 has game symbols 10 arranged into an array 11 in the form of five columns or “reels” 12. The reels 12 give the visual appearance of rotating, typically by having the game symbols 10 move in a downward linear path along the length of each reel 12. While the array 11 is arranged with five reels 12 and three rows as per the industry standard, it will be appreciated by one skilled in the art that other types of arrays could be used, such as 3×3, 4×3, 5×5, 4×4, etc, including arrays having an irregular number of rows and/or columns. For example, the array 11 can have an unequal number of rows and/or columns, where some columns have less or more rows than other columns or where some rows have less or more columns than other rows. A more specific example would be an array having three columns with only two rows and two columns with three rows. The electronic game controller 4 will transmit signals to the display screen 7 to cause the base game 8 and feature game 9 to be played on the lower playing area 7a, including showing the game symbols 10, array 11 and other visible elements of the games.

The array 11 of the base game 8 defines predetermined game or symbol positions 13, in which the game symbols 10 appear. The symbol positions 13 are not visually marked by boundary lines and simply provide an area for the game symbols 10 to appear. However, it will be appreciated that in other embodiments, the symbol positions 13 are defined by visible boundary lines (to define “squares” or game positions) or other markings to define each respective area of the symbol positions.

The array 11 is arranged so that a player can select one or more predetermined “pay lines” 14 defined around the array, which correspond to combinations of the symbol or game positions 13. The pay lines 14 correspond to the lines selected by the player and generally comprise at least one game position or symbol position 13 from each reel 12. The number of pay lines 14 that can be selected by the player depends on the amount of the monetary bet for playing a game on the array 11. In the base game 8, predetermined winning combinations of randomly selected game symbols 10 result in the award of prizes to the player.

The game symbols 10 can include a mixture of picture symbols (such as animal symbols or playing card symbols), word symbols, scatter symbols, substitute or wild card symbols and trigger symbols to trigger the feature game 9. Those skilled in the art will readily understand that a substitute symbol is able to act as any other game symbol, and hence is also known as a “wild card” symbol. Likewise, those skilled in the art will readily understand that a scatter symbol is a symbol that triggers a game event or confers an award without having to appear on a player-selected pay line 14. Similarly, a trigger symbol is a symbol that triggers a game event or confers an award, where the trigger symbol may or may not have to appear in combination and may or may not have to appear on the same player-selected pay line 14. In a typical game shown in FIG. 3, the game symbols 10 include playing card symbols 10a, animal-themed symbols 10b, item-themed symbols 10c, scatter symbols in the form of “wolf banner” symbols 10d and a substitute or wild card symbol in the form of horse symbols 10e. The electronic game controller 4 randomly determines the appearance of the game symbols 10 on the array 11.

The video screen 7 also displays other standard game information in the lower playing area 7a, including the number of pay lines available 15, the number of player-selected pay lines 16, the amount of player credits 17 (i.e. credit meter), the amount of the current bet wagered by the player 18 (i.e. bet meter), the amount of wins by the player 19 (i.e. win meter), a message area 20, a current denomination button 21 indicating the currently selected base bet denomination and the name 24 of the base game 8, Wolf Chief™, as best shown in FIG. 3. In other embodiments, the video screen 7 displays a menu button for bringing up a menu screen (typically explaining the game rules and showing the available pay lines 14) and/or jackpot information relating to the based game 8 and feature game 9 that are awarded by the electronic gaming machine 1. This jackpot information is typically displayed in the upper display area and can comprise, in descending order of monetary value, a grand jackpot, major jackpot, minor jackpot and midi jackpot. These jackpots are typically standalone progressive jackpot prizes, but could take other forms, as discussed in more detail below.

The electronic game controller 4 communicates with the vending slots 5 to determine the amount of the monetary bet or value entered by the player into the electronic gaming machine 1. If there is a threshold amount of the monetary bet or value corresponding to a minimum amount of credits to play the game 8, then the electronic game controller 4 causes the display to indicate the amount of credits in the credit meter 17 and the minimum amount of the bet in bet meter 18. The player is then able to operate the buttons 6 to activate a play of the game 8 on the electronic gaming machine 1. Of course, where the amount of the monetary bet or value exceeds the threshold amount, the electronic game controller 4 enables the higher bets to be made by the player. If there is an insufficient amount of the monetary bet or value, the electronic game controller 4 will cause the display 7 to display a message to the effect that there is insufficient credit to play the game. Alternatively or additionally, the credit meter 17 is highlighted by an animation or flashing lights to indicate that additional value needs to be entered before the game 8 can be played.

In the base game 8, the player initially makes a bet using vending slots 5 to initiate play of the gaming machine 1 by building up credit to play the base game 8 on the gaming machine. For example, the player can bet or wager monetary amounts equivalent to a particular amount of credits, depending on the bet denomination selected for the base game. Also, the player can make any additional side bets or ante-bets during play of the base game 8 once the base game has commenced to access additional features in the base game, such as increasing the number of winning combinations in the base game.

Typically, gaming machines offer a number of preset bet options that the player can make, and these bet options can vary depending on the game or games offered on the gaming machine. For example, a game on a gaming machine may provide bet options of 1 credit, 2 credits, 5 credits and 10 credits per player-selected pay line 14. In another example, the player may bet 1 credit, 2 credits, 5 credits and 10 credits for a preset group or combination of pay lines 14, such as a group of 5 pay lines, 10 pay lines, 20 pay lines, etc.

The gaming machine 1 also has a default bet denomination, which is usually the bet denomination that was previously used in the preceding play of the base game 8. For example, if a person had played the base game 8 with a bet denomination of 5¢, then this would be the default bet denomination for the player when he or she commences play of the game. Where the gaming machine has not yet been played or has been started up, the default bet denomination is initially selected by the electronic game controller 4. The default bet denomination can be randomly selected or chosen according to a predetermined order. Usually, the electronic game controller 4 will select the bet denomination with the lowest value that is available for the base game 8, which would be the 1¢ bet denomination for this embodiment. The player may change the bet denomination at any time in the base game 8 by touching the denomination button 21 before or after the reels 12 have spun. In this embodiment, touching the denomination button will bring denomination images 28, 29 that the player may select to quickly change the bet denomination between plays of the game 8.

Once the player has commenced play of the game 8 by making an appropriate bet or wager via the vending slots 5, the amount of the bet or wager is assessed by either the verification device associated with the vending slots 5 and/or the metering module 4d. If the amount of the bet is sufficient to at least meet the threshold of the minimum bet permitted to play the base game 8, the electronic controller 4 then commences a play of the base game 8 by sending a signal to the display 7 to cause the reels 12 to appear to visibly rotate or “spin” in a linear path, typically in a downward vertical direction, and randomly display the game symbols 10 in each game position for each play of the array 11 for the base game 8. The electronic game controller 4 randomly selects the game symbols 10 using the processor 4a with the random number generator 4e. After the reels 12 stop spinning (and thus ends the spin or play of the base game 8), the electronic game controller 4 determines whether there are any predetermined winning combinations of the game symbols 10 appearing in any player-selected pay lines 14, such as a two of a kind, three of a kind, four of a kind or five of a kind for all the game symbols 10 and other combinations of a “full house”, “straight” or “flush” for the playing card game symbols 10a. It will be appreciated that other winning combinations of game symbols 10 can also be provided. If so, the gaming machine 1 enters a winning game state and awards a prize according to the displayed predetermined winning combination.

The electronic game controller 4 also determines whether the feature game 9 should be activated, based on a predetermined feature game trigger event, such as the appearance of a number of trigger symbols appearing in a play or spin of the base game 8. In this embodiment, the feature game trigger event is the appearance of three scatter symbols 10d. The scatter symbols 10d need not appear on the same pay line 14, but can appear on any of the player-selected pay lines, as best shown in FIG. 3.

In response to the trigger event, the electronic controller 4 then transmits a signal to the video screen 7 to cause the feature game 9 to appear on the video screen 7. The feature game 9 as shown in FIG. 3 is an enhanced version of the base game 8. The feature game 9 also uses the same array 11, reels 12, game positions 13 and player-selectable pay lines 14 as the base game 8 on the video screen 7. The feature game 9 operates in a similar manner to the base game 8, where the reels 12 visibly rotate and display randomly selected game symbols 10 in each game position 13. Predetermined winning combinations of randomly selected game symbols 10 in the array 11 of the feature game 9 also result in the award of prizes to the player, usually of an enhanced value compared to the prizes awarded in the base game 8, and/or with an increased frequency (i.e. the feature game 9 has higher win probability compared to the base game 8).

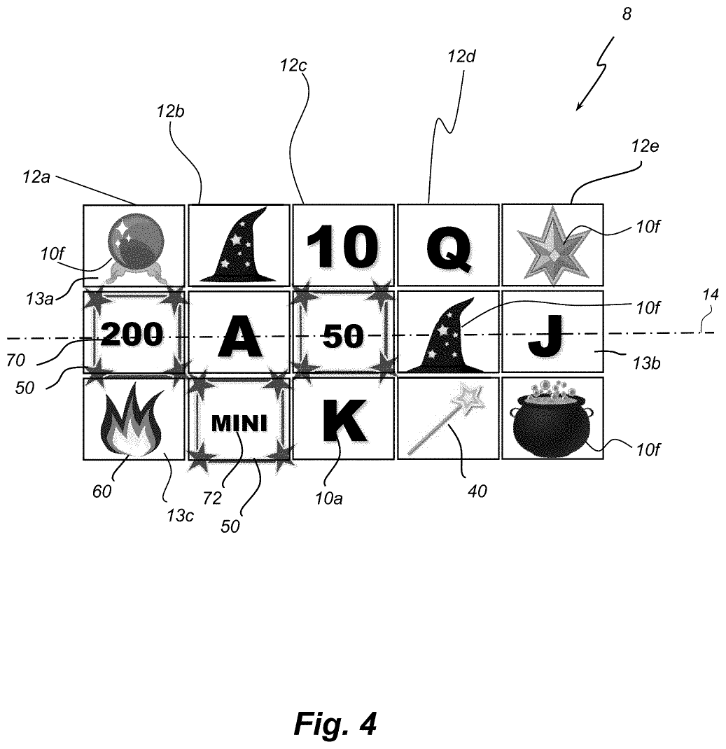

Referring to FIG. 4, one embodiment of the present disclosure is shown, where a base game 8 is provided a magic theme having matching picture symbols 10f in the form of a cauldron, wizard hat, magic jewel and crystal ball. In addition to playing card symbols 10a and picture symbols 10f, there are substitute symbols in the form of a wand symbol 40, a special symbol in the form of a magic square symbol 50 and an activator symbol in the form of a flame symbol 60. The special symbols 50 have an associated game enhancing element 70, 72, 75 in the form of a credit prize, bonus prize or an award of free games, respectively. The game enhancing elements 70, 72, 75 are randomly selected and associated with each special symbol, as well as being shown on the special symbol 50.

The base game 8 operates in substantially the same way as described in relation to FIG. 3 and so a detailed description of the base game 8 will be omitted. It should also be noted that in the embodiment of FIG. 4, the various visual elements of the base game 8, such as standard game information like the number of pay lines available 15, the number of player-selected pay lines 16, the amount of player credits 17, the amount of the current bet wagered by the player 18, message area 20 and current denomination button 21, have been removed for clarity purposes. However, the base game 8 has the same or similar visual elements and features of the base game 8 of FIG. 3, such as reels 12a to 12e, symbol or game positions 13 and pay lines 14a, 14c, 14d.

Unlike the base game 8 in FIG. 3, the trigger event for triggering a feature game 9 is the appearance of at least three special symbols 50 with at least one activator symbol 60, as shown in FIG. 4. If there is an insufficient number of either the special symbols 50 or the activator symbols 60, then the feature game 9 is not triggered, even if there is a total of four or more symbols that are a combination of special symbols and activator symbols. For example, if there are less than three special symbols 50 and two or more activator symbols 60 that appear in a play or spin of the base game 8, this would not trigger the feature game 9. Similarly, if there are four activator symbols 60 but no special symbols 50, then this would also not trigger the feature game 9. Likewise, if four or more special symbols 50 that appear in a play, but not an activator symbol 60, this would not trigger the feature game 9. It should be appreciated that the number of special symbols 50 and activator symbols 60 required to trigger the feature game 9 may vary. For example, there could be a combination of at least one special symbol 50 and at least one activator symbol 60. Alternatively, there could be a combination of at least one special symbol 50 and at least two activator symbols 60. Other combinations of special symbols 50 and activator symbols 60 may be used.

The special symbols 50 are associated with a game enhancing element that modifies the outcome of a play or spin of the reels 12 in the feature game 9. In this embodiment, the game enhancing element is a credit prize 70, like 200 credits, or a bonus prize 72, such as a mini, minor or major jackpot, indicated by the words MINI, MINOR and MAJOR, respectively, appearing on the special symbol 50. Each type of game enhancing element may provide different types of effects or modifications of the game play result. In a further embodiment, the credit prize values 70 of the special symbols 50 are predefined multiples of the total bet until they reach a capped amount or a jackpot value. For example, the first spin may use credit prize values ×2 of the total bet, the second spin a credit prize value of ×3 of the total bet, the third spin may use credit prize values ×5 of the total bet, and so on in stepwise increments of ×8, ×10, ×15, ×20, ×25, ×40, ×50 and ×100 of the total bet or the Grand jackpot. The amount can be capped at any stage as desired.

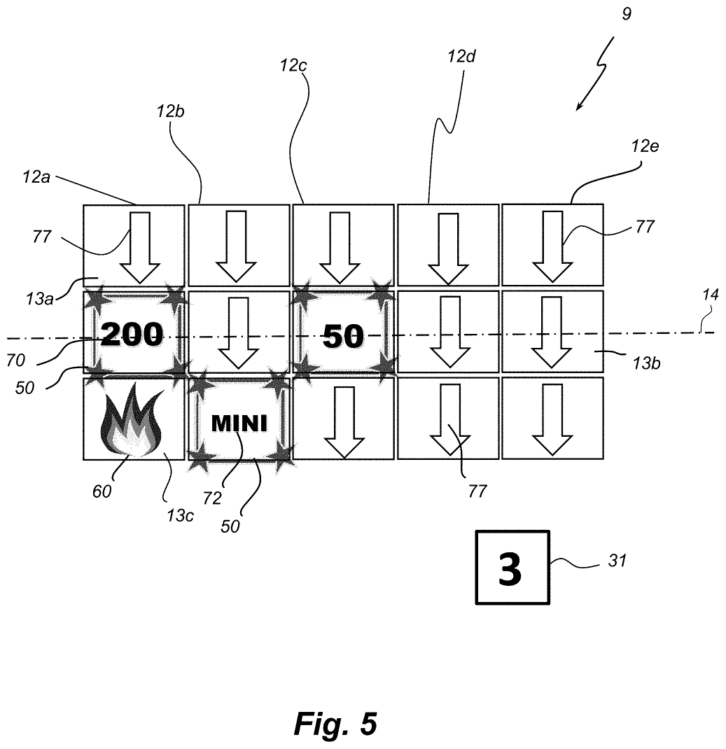

In response to the trigger event, the electronic game controller 4 then transmits a signal to the video screen 7 to cause the feature game 9 to appear on the video screen 7, as best shown in FIGS. 5 to 8. In this embodiment, the feature game 9 awards three free plays or spins of the feature game are awarded to the player without having to make an additional bet or wager. It will be understood by those skilled in the art that a free play or spin involves a play of the game without requiring any bet to be made by the player, and that any number of free spins can be chosen for the feature game 9. In addition, it will be appreciated that in the art free spins are commonly referred to as “free games”. The number of free games remaining in the feature game 9 is indicated by a counter 31.

The feature game 9 employs the same array 11, reels 12, game positions 13 and player-selectable pay lines 14 as the base game 8. Again, it should also be noted that in FIGS. 5 to 13, the various visual elements of the feature game 9, such as standard game information like the number of pay lines available 15, the number of player-selected pay lines 16, the amount of player credits 17, the amount of the current bet wagered by the player 18, message area 20 and current denomination button 21, have been removed for clarity purposes.

The feature game 9 operates in a similar manner to the base game 8 where the reels 12 visibly rotate and display randomly selected game symbols 10 in each game position 13. However, the special symbols 50 and the activator symbol 60 are kept or “held” in the same game position 13 that they initially appeared on the reels 12 for each subsequent play or free spin for the duration of the feature game 9, while the other game positions 13 in the reels 12 are repsun, as best shown by arrows 77 in FIG. 5. This “hold and spin” aspect of the feature game 9 only applies to the special symbols 50 and the activator symbol 60. Any game symbols 10 (including playing card symbols 10a and picture symbols 10f) that appear on the reels 12 are inactive and do not contribute to any winning combination of symbols in the feature game 9; only the special symbols 50 are able to trigger the award of credit or other prizes in the feature game 9. In some embodiments, the game symbols 10 are blacked out or fade into the background of the game positions, where they can only be faintly seen, to emphasise that they do not contribute to any combination of symbols that award prizes in the feature game 9. Credit prizes are awarded to the player at the conclusion of each free spin and are calculated on the amounts of the credit prize or bonus prize shown in the special symbols 50 that appear on the reels 12.

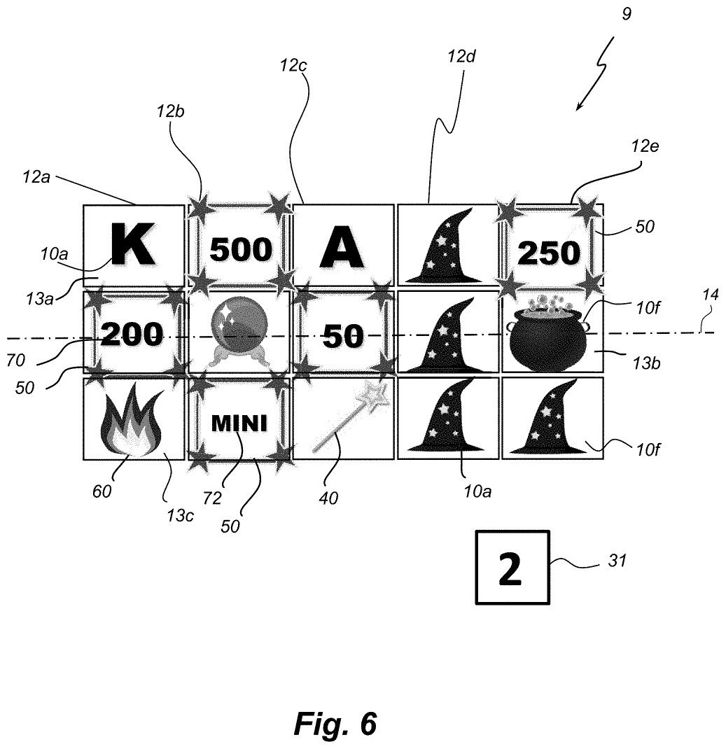

FIG. 6 illustrates the first free spin of the feature game 9, where two special symbols 50 appear in the reel 12b at the top game position 13a and reel 12e in the top game position 13a. As stated above, the original three special symbols 50 and activator symbol 60 from the initial spin of the base game 8 have been held in the middle game position 13b of the reel 12a, bottom game position 13c of the reel 12b, bottom game position 13c of the reel 12c and bottom game position 13c of the reel 12a, respectively. This results in the award of a credit prize that is the sum of the credit prizes 70 and amount of the mini jackpot 72 indicated by each special symbol 50. Assuming a mini jackpot prize of 300 credits, the total amount of the awarded credit prize is 1300 credits. This credit prize is awarded instantly to the player and may be associated with a suitable image or animation of the credit prize shown on the reels 12 before disappearing and/or moving up to the win meter 19 in the upper display area. In other embodiments, the image may float or move to the credit meter 17 and/or win meter 19 in the lower display area 7a to add the amount of the awarded credit prize to the credit meter or win meter. The free games counter 31 decrements to show only two free spins remaining in the feature game 9.

While three special symbols 50 appeared on the first play of the feature game 9, the electronic game controller 4 may randomly select whether to display game symbols 10, special symbols 50 or activator symbols 60 for each game position 13 in the reels 12a to 12e, using the processor 4a with the random number generator 4e. Hence, more or less special symbols 50 and activator symbols 60 may appear on the reels 12, or even none at all. In this embodiment, the special symbols 50 that appeared in the base game 8 and triggered the feature game 9 carry over the first play of the feature game, as shown in FIG. 6.

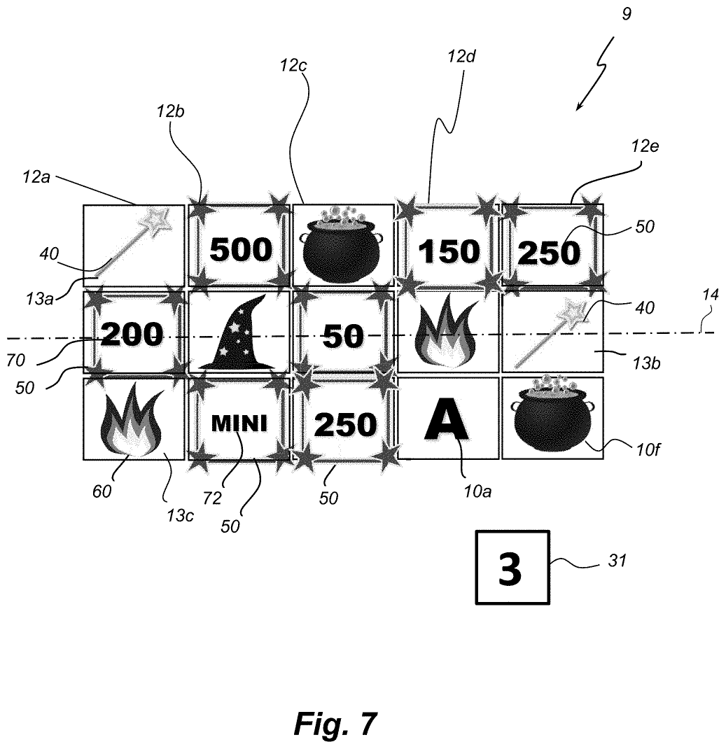

FIG. 7 illustrates the next (second) free spin of the feature game 9, where two more special symbols 50 appear in the reel 12c at the bottom game position 13c and reel 12d in the top game position 13a. Also, another activator symbol 60 has appeared in the middle game position 13b of reel 12d. The previously displayed special symbols 50 and special symbol 60 have been held in their same positions. In this embodiment, a credit prize of 1700 credits is awarded instantly to the player for the appearance of the special symbols 50 now shown on the array 11. In other embodiments, the credit prize may be limited to only the newly added special symbols, which in this base would be 400 credits (for the special symbols 50 having credit prizes of 150 and 250 credits). The second activator symbol 60 appearing on the array 11 causes the free games counter to be reset to the maximum of three free games, prolonging the gameplay of the feature game 9.

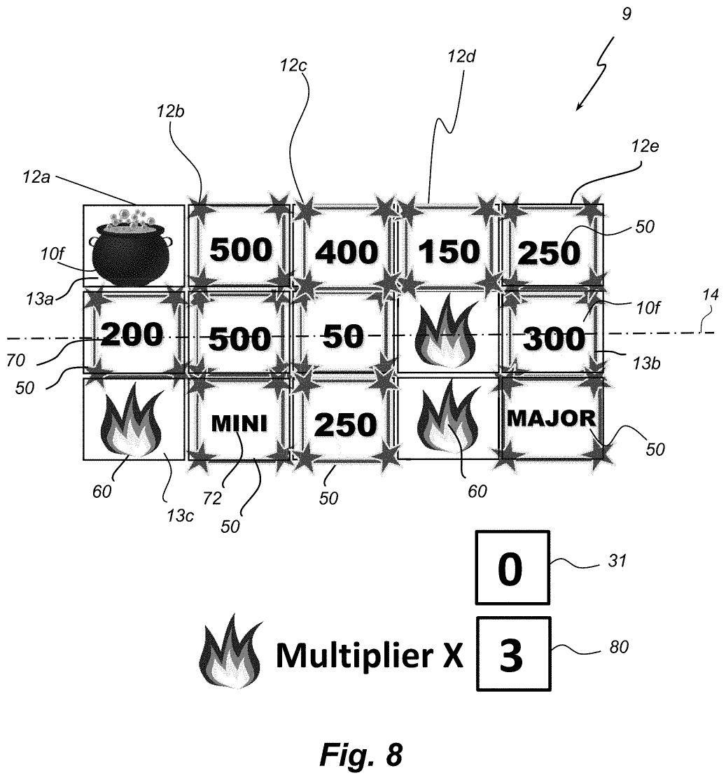

FIG. 8 illustrates the final free spin of the feature game 9, where all but the top game position 13a of the reel 12a has been filled with special symbols 50 or activator symbols 60. At the conclusion of this last free spin, a credit prize of 3900 credits is initially awarded instantly to the player, being a total of the credit prizes (2600 credits) and bonus prizes (300 credits for the Mini jackpot and 1000 credits for the Major jackpot) associated with the special symbols 50. In this embodiment, the number of activator symbols 60 are counted or totalled to award a multiplier that is applied to the total amount of credits won in the feature game 9, as shown by activator symbol counter 80. For example, if the player had won a total of 12000 credits in the feature game, this would be multiplied by the awarded multiplier ×3 to award 36000 credits at the end of the feature game. Alternatively, the activator symbol counter 80 may be displayed at all times to show how many activator symbols the player is accumulating in the feature game 9.

In other embodiments, the multiplier conferred by the activator symbol 60 may be applied at the end of each free spin, rather than at the end of the feature game 9. In this instance, there would be an ×1 multiplier applied to the credits won in the spin or play of the feature game 9 shown in FIG. 6 and an ×2 multiplier applied to the credits won in the spin or play of the feature game shown in FIG. 7. Also, the activator symbol counter 80 is displayed on the lower screen 7a during each play of the feature game 9 to show the current multiplier applicable.

In further embodiments, a range of multiplier values for association with the activator symbol 60 may be selected by the electronic game controller 4 depending on the bet made by the player to play the base game 8. For example, a bet of 50¢ may only provide a multiplier value of ×1, whereas a bet of $1 may provide a multiplier value of ×2 and a bet of $2 may provide a multiplier value of ×5. It will be appreciated that different multiplier values for the activator symbol 60 may be used to cater for the range of bets that can be made.

In yet another embodiment, the activator symbol 60 may be a multiplier symbol instead of a specific picture symbol. That is, the activator symbol 60 may be a symbol with an ×1 image. However, in this case, the multiplier symbol does not change between plays of the feature game 9 but stays the same throughout the feature game. For example, in FIG. 7, there would be two ×1 multiplier symbols that would add or stack to provide the ×2 multiplier, but not replaced with a multiplier symbol with an ×2 image.

Furthermore, if the last game position 13a of reel 12a in FIG. 8 had been filled with a special symbol 50 or activator symbol 60, then the feature game 9 would award the Grand jackpot as reward for filling each game position 13 with a special symbol or activator symbol. The award of the Grand jackpot is in addition to the above award of the credit prizes at the end of the last free spin and at the conclusion of the feature game 9.

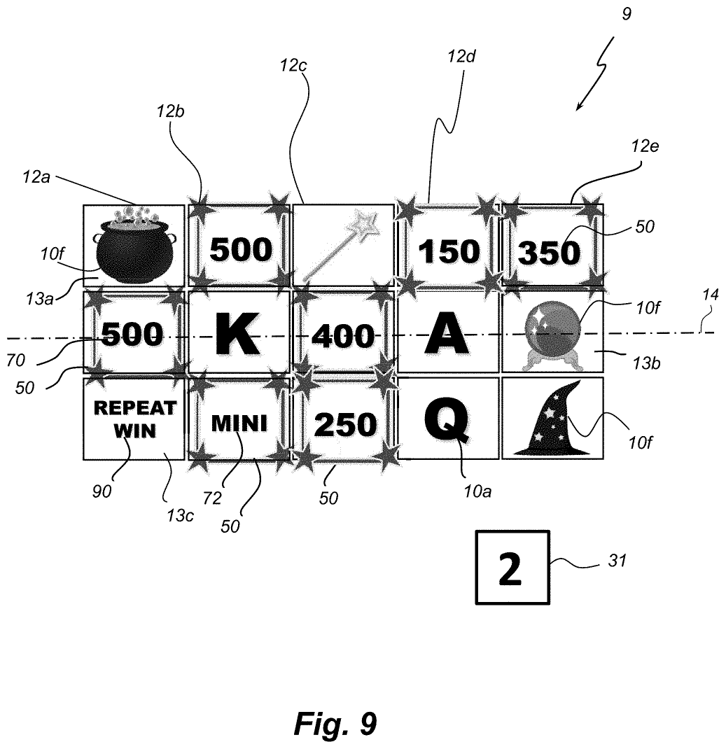

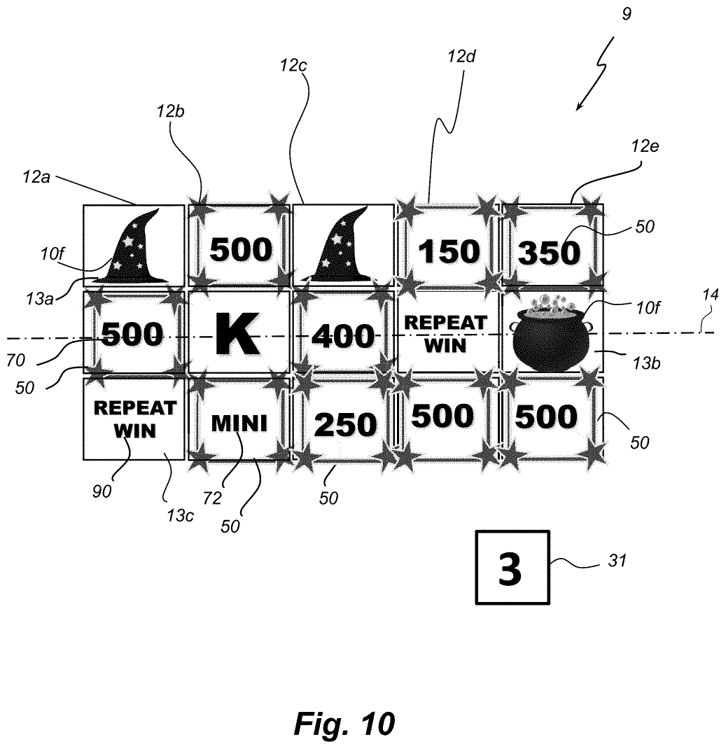

In an alternative embodiment shown in FIGS. 9 and 10, the activator symbol is a REPEAT WIN symbol 90, where the credit prizes won in each free spin of the feature game 9 are paid again instead of accumulating activator symbols 60 to obtain a multiplier. For example, in FIG. 9, credit prizes of 2650 credits have been won in this play of the feature game 9 (assuming the Mini jackpot is 300 credits). This total amount of this credit prize is initially paid, then the REPEAT WIN symbol 90 is animated or highlighted (such as temporarily expanding in size for emphasis) and the amount of 2650 credits is paid again, awarding a total amount of 5300 credits, effectively being an ×2 multiplier. This is repeated for each free spin of the feature game 9, so that as more special symbols 50 appear on the reels 12, the amount of the credit prizes significantly increases. In the next spin shown in FIG. 10, another REPEAT WIN symbol 90 appears in the middle game position 13b of reel 12d and two special symbols 50 having associated credit prizes of 500 appear in the bottom game positions 13c of reels 12d and 12e. This results in an award of 3650 credits being initially paid, which is then repeated twice, once for each REPEAT WIN symbol 90. That is, 3650 credits are initially paid, then one of the REPEAT WIN symbols 90 animates or is highlighted and 3650 credits are paid again and then the other REPEAT WIN symbol 90 animates or is highlighted, awarding another 3650 credits, totalling 10950 credits. In addition, the additional appearance of the REPEAT WIN symbol 90 resets the free games counter 31 back to 3.

It should be evident that the activator symbols 60, 90 are unlike the special symbols 50 in that they have a preset function, whereas the special symbols have randomly allocated credit prize or bonus prize values assigned to them as they appear on the reels 12 in the feature game.

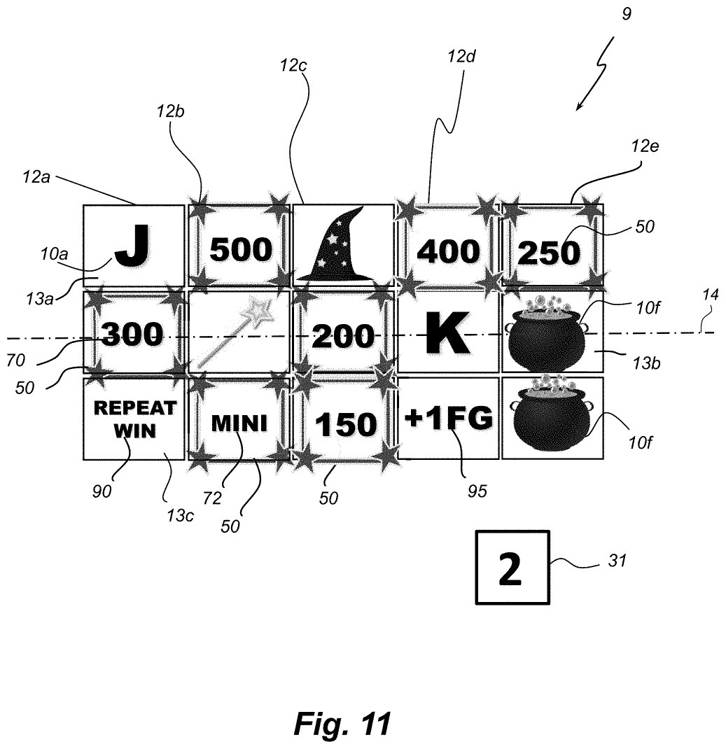

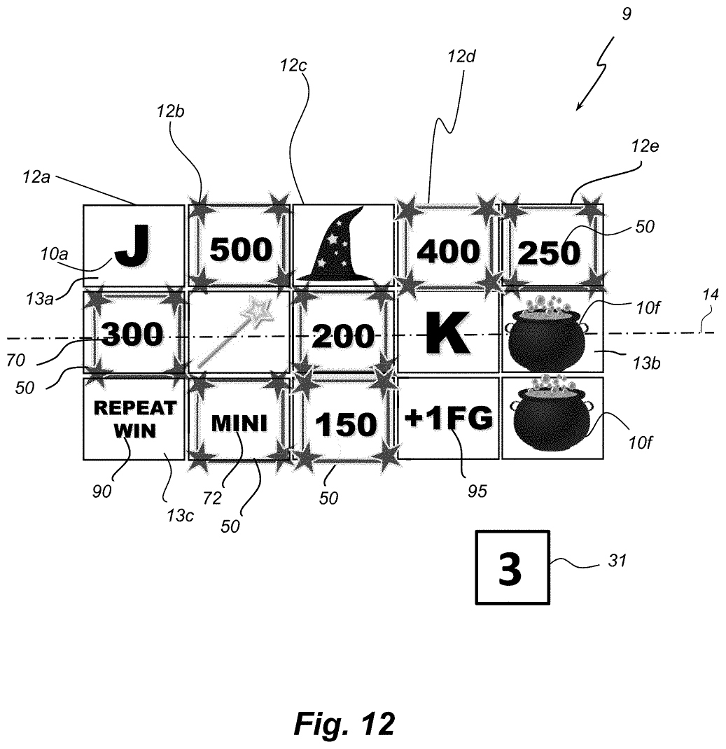

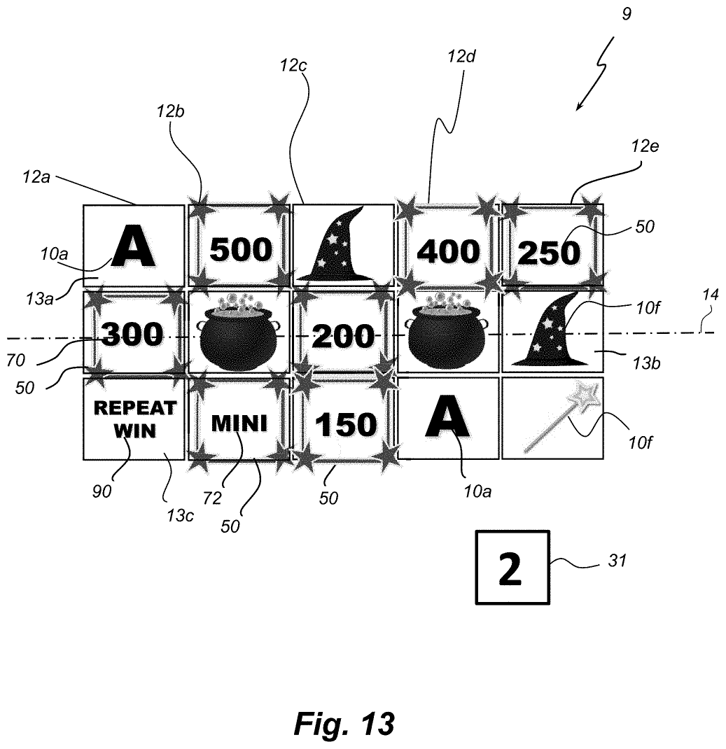

A further embodiment is shown in FIG. 11, where a free games symbol 95 may be randomly selected by the electronic game controller 4 to appear in the feature game 9 in game positions 13 of the reels 12. The appearance of the free games symbol 95 increases the number of free spins remaining in the feature game 9 instead of the activator symbol 60, 90. In FIG. 11, the free games symbols 95 has appeared in the bottom game position 13c of the reel 12d, having a value of +1 to add an extra free spin to the feature game, increasing the number of free spins by 1. This is indicated by +1 image on the free games symbol 95 expanding and moving to the free games counter 31, which is incremented by the value of one for the free games symbol 95, as shown in FIG. 12. After incrementing the free games counter 31, the free games symbol 95 may either disappear or stay in the game position 13 until the next free spin. This allows another game symbol 10, special symbol 50, activator symbol 90 or even another free games symbol 95 to occupy the game position 13c that had been previously occupied by the free games symbol 95. As best shown in FIG. 13, in the next free spin the bottom game position 13c of the reel 12d is now occupied by a playing card A (ace) symbol 10a. In the embodiment, the free games symbol 95 may have values of +1, +2, +3 or +5 to increase the number of free spins or plays of the feature game 9 by the corresponding amount of 1, 2, 3 and 5, respectively. This reset or incrementing of the free games counter 31 occurs independently of the number of special symbols 50 or activator symbols 90 appearing on the reels 12. In addition, the free games symbol 95 may also be associated with a randomly selected credit prize, but is not held on the reels 12, unlike the special symbols 50. For example, the free games symbol 95 may read as 100+2 FG, indicating a credit prize of 100 credits and an extra two free games being awarded.

In yet another embodiment of the present disclosure, a predetermined number of special symbols 50 triggers a mini-game to see if an activator symbol 60 appears to trigger the feature game 9. In this case, the reels 12 are spun with the special symbols 50 held in their game positions 13 while games symbols 10, including the special symbol 50 and activator symbol 60, are randomly selected for display in the remaining game positions 13. If the activator symbol 60 appears in this respin or mini-game, then the feature game 9 is triggered. If the activator symbol 60 does not appear, then the array 11 reverts back to the base game 8. In one embodiment, the number of special symbols 50 required to trigger this mini-game is six special symbols. However, any number of special symbols 50 may be used to trigger the mini-game, such as five special symbols or seven special symbols. In a further embodiment, upon the predetermined number of special symbols 50 appearing in the base game 8, the game controller 4 uses the random number generator 4e to determine whether to initiate the mini-game to see if an activator symbol 60 appears to trigger the feature game 9. That is, the mini-game may be initiated randomly rather than being automatically triggered by the predetermined number of special symbols 50. The probability of the mini game being initiated randomly in this embodiment may be determined using a separate weighting table that takes into account the amount of the player's total bet made in the base game 8. In another embodiment, the probability of the activator symbol 60 in the mini game may also be determined using a separate weighting table that takes into account the amount of the player's total bet made in the base game 8. In either case, the higher the amount of the player's total bet made, the higher the probability of mini-game being triggered or the activator symbol 60 being displayed, respectively.

It will be appreciated that in the present disclosure, the game enhancing element associated with the special symbol 50 is awarded immediately and without any determination whether to award the prize. That is, once the special symbol 50 appears in the reels 12a to 12e, the electronic controller 4 must or always award the game enhancing element associated with the special symbol 50. There is no further determination, random or otherwise, whether to award the game enhancing element once the trigger condition has been met.

Thus, the embodiments of the disclosure provide a unique mechanism for a gaming machine to trigger a feature game or enhanced game play by using a combination of special symbols and an activator symbol where the special symbols 50 award randomly selected game enhancing elements, like credit or jackpot prizes. Hence, this combination provides a unique and entertaining method for triggering feature game or enhanced game play for players in a gaming machine compared to prior art gaming machines. In addition, in the specifically described embodiments, the award of randomly selected game enhancing elements associated with the special symbols 50, as well as a predefined benefit from the activator symbol 60, 90. Hence, this combination of awarding both random game enhancing elements from special symbols 50 and fixed or known game enhancing elements from the activator symbols 60, 90 embodiments of the disclosure provide a unique alternative to the award of game enhancing elements to a player compared to existing gaming machines. In addition, the embodiments of the disclosure provide a unique player interface that enables players to quickly ascertain what game enhancing elements can be won during the feature game. Thus, the award of game enhancing elements may be performed in an entertaining manner to the player. This overall improves operation of the gaming machine and increases the player's interest as there is more chance of winning additional prizes due to the award of these game enhancing elements.

In other embodiments, the prizes or game enhancing elements awarded for the special symbols 50 is in addition to any predetermined winning combinations of game symbols 10a, 10f, 10g that may be displayed on one of the pay lines 14 on the reels 12a to 12e. These winning combinations of game symbols 10a, 10f and 10g may either be two of a kind, three of a kind, four of a kind or five of a kind for all the game symbols 10a, 10f and other combinations of a “full house”, “straight” or “flush” for the playing card game symbols 10a, the same as in the base game 8. The substitute wand symbols 10g only substitute game symbols 10a, 10f for winning combinations on a player-selected pay line 14 and does not substitute for the special symbol 50 or the activator symbol 60, 90. However, the special symbol 50 may act as a substitute or wild symbol for the purpose of determining predetermined winning combinations of game symbols 10.

In other embodiments, the credit prize may be calculated instead on the number of special symbols 50 appearing in a free spin (not the total number of special symbols 50 displayed on the reels 12) and is a multiple of the total credits bet for the spin of the base game 8 that activated the feature game 9. Generally, the credit prize is calculated by multiplying the number of special symbols 50 by a base credit prize. The base credit prize is calculated by applying a predetermined multiplier to the total credits bet. The predetermined multiplier applied to the total credits bet in this embodiment may be ×1, ×2, ×5 or ×10. The selection of the predetermined multiplier may be determined according to the number of lines and/or the bet denomination selected by the player; more lines and/or higher bet denominations will increase the multiplier. Also, a higher bet or wager made in the activating spin in the base game 8 increases the credit prize awarded in the feature game 9 for the appearance of a special symbol 50.

In other embodiments, the amounts of the credit prizes awarded by special symbols increase as a bet multiplier increases, the bet multiplier being the amount bet by the player per pay line 14. For example, a bet multiplier of 2 means a bet of 2 credits per pay line 14, irrespective of the number of pay lines (2, 5, 10, etc.) that are selected to play the base game 8. Thus, the amounts of the credit prizes will only increase if the bet multiplier increases, irrespective of the amount of the total bet. Similarly, the probability of the jackpot prize being awarded through the jackpot-type bonus symbols also increases with an increase in the total bet made by the player. This may be achieved by using different reel strips with a greater number of jackpot-type bonus symbols for the reels 12a to 12e.

In some embodiments, the frequency of the special symbols displayed in the array controlled by choosing different reel strips to display the special symbols 65, 75 in the base game 8 and feature game 9. Thus, more special symbols as the bet made by the player increases. This means that the frequency of potentially associating prize(s) with the special symbols and winning those associated prize(s) increases. There may also be a combination of frequency of the special symbols and using different reel strips for reels with a higher frequency of higher worth game symbols or substitute symbols.

It will be appreciated that one skilled in the art will recognise that the term “volatility” refers to the expected frequency of winning game events occurring and the corresponding amount paid for each winning game event in order to maintain the required payout level set for the gaming machine. Thus, the amount paid for each winning combination and the level of return to the player determines the “volatility” of the gaming machine. For example, a gaming machine with low volatility is configured to have a relatively high frequency of “wins”, where each win has a relatively low value. Conversely, high volatility refers to a lower frequency of “wins” of correspondingly higher value. Throughout the specification, “volatility” is a reference to this characteristic of a gaming machine.

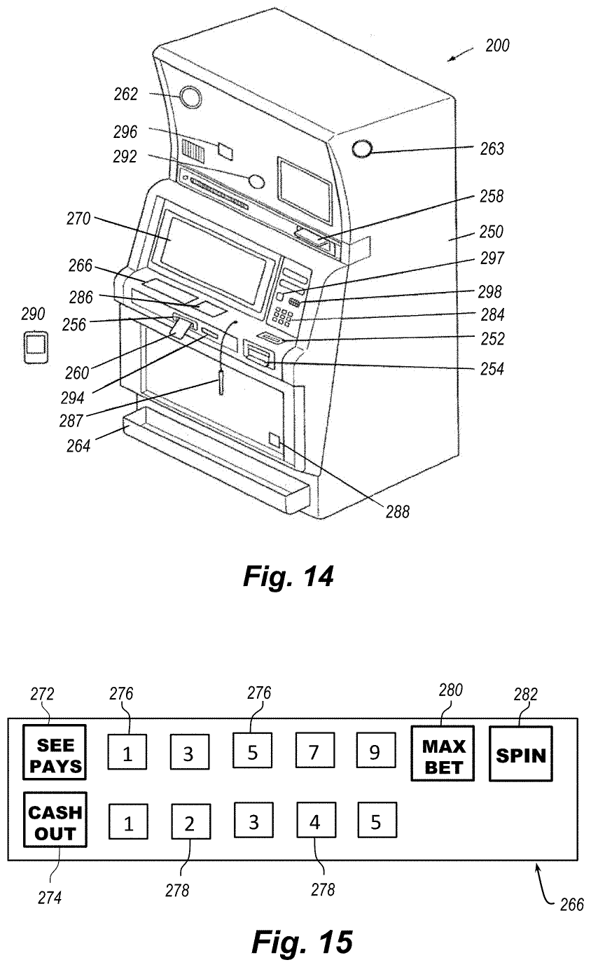

Referring to FIG. 14, another embodiment is shown in the form of an electronic gaming machine 200. The electronic gaming machine 200 may include a housing or cabinet 250 and one or more value transfer mechanisms or devices, which may include a coin slot or acceptor 252, a paper currency or bill acceptor 254, a ticket reader/printer 256 and a card reader 258, which may be used to input value to the electronic gaming machine 200. A value transfer device may include any device that can accept value from a player. The topper (not shown) may be mounted to the top of the electronic gaming machine 200.

If provided on the electronic gaming machine 200, the ticket reader/printer 256 may be used to read and/or print or otherwise encode ticket vouchers 260. The ticket vouchers 260 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 260 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 260 could be printed with an optically readable material such as ink, or data on the ticket vouchers 260 could be magnetically encoded. The ticket reader/printer 256 may be provided with the ability to both read and print ticket vouchers 260, or it may be provided with the ability to only read or only print or encode ticket vouchers 260. In the latter case, for example, some of the electronic gaming machines 200 may have ticket printers 256 that may be used to print ticket vouchers 260, which could then be used by a player in other electronic gaming machines 200 that have ticket readers 256.

If provided, the card reader 258 may include any type of card reading device, such as a magnetic card reader or an optical card reader, and may be used to read data from a card offered by a player, such as a credit card or a player tracking card. If provided for player tracking purposes, the card reader 258 may be used to read data from, and/or write data to, player tracking cards that are capable of storing data representing the identity of a player, the identity of a casino, the player's gaming habits, etc.

The electronic gaming machine 200 may include one or more audio speakers 262, a coin payout tray 264, an input control panel 266, and a colour video display unit 270 for displaying images relating to the game or games provided by the electronic gaming machine 200. The audio speakers 262 may generate audio representing sounds such as the noise of spinning reels, a dealer's voice, music, announcements or any other audio related to a game. The input control panel 266 may be provided with a plurality of pushbuttons or touch-sensitive areas that may be pressed by a player to select games, make wagers, make gaming decisions, etc.

FIG. 15 illustrates one possible embodiment of the control panel 266, which may be used where the electronic gaming machine 200 having a plurality of reels. The control panel 266 may include a “See Pays” button 272 that, when activated, causes the display unit 270 to generate one or more display screens showing the odds or payout information for the game or games provided by the electronic gaming machine 200. As used herein, the term “button” is intended to encompass any device that allows a player to make an input, such as an input device that must be depressed to make an input selection or a display area that a player may simply touch. The control panel 266 may include a “Cash Out” button 274 that may be activated when a player decides to terminate play on the electronic gaming machine 200, in which case the electronic gaming machine 200 may return value to the player, such as by returning a number of coins to the player via the payout tray 264.

The control panel 266 may be provided with a plurality of selection buttons 276, each of which allows the player to select a different number of pay lines prior to spinning the reels. For example, five buttons 276 may be provided, each of which may allow a player to select one, three, five, seven or nine pay lines.

The control panel 266 may also be provided with a plurality of selection buttons 78 each of which allows a player to specify a wager amount for each pay line selected. For example, the electronic gaming machine 200 may be provided with five selection buttons 78, each of which may allow a player to select 1¢, 2¢, 5¢, 10¢ and 20¢, to wager for each pay line selected. In that case, if a player were to activate one of the buttons 276 to select five pay lines and then activate one of the buttons 278 to select 5¢ per pay line to be wagered or bet, the total wager would be $0.25.

The control panel 266 may include a “Max Bet” button 280 to allow a player to make the maximum wager allowable for a game. In the above example, where up to nine pay lines were provided and up to 20¢ could be wagered for each pay line selected, the maximum wager would be $1.80 The control panel 266 may include a spin button 282 to allow the player to initiate spinning of the reels after a bet has been made.

In FIG. 15, a rectangle is shown around the buttons 272, 274, 276, 278, 280, 282. It should be understood that the rectangle simply designates, for ease of reference, an area in which the buttons 272, 274, 276, 278, 280, 282 may be located. Consequently, the term “control panel” should not be construed to imply that a panel or plate separate from the housing 250 of the electronic gaming machine 200 is required, and the term “control panel” may encompass a plurality or grouping of player activatable buttons.

Although one possible control panel 266 is described above, it should be understood that different buttons could be utilized in the control panel 266, and that the particular buttons used may depend on the game or games that could be played on the electronic gaming machine 200. Although the control panel 266 is shown to be separate from the display unit 270, it should be understood that the control panel 266 could be generated by the display unit 270. In that case, each of the buttons of the control panel 266 could be a coloured area generated by the display unit 270, and some type of mechanism may be associated with the display unit 270 to detect when each of the buttons was touched, such as a touch-sensitive screen.

As noted above, the electronic gaming machine 200 may include a mechanism by which the electronic gaming machine 200 may determine the identity of the player. In particular, the card reader 258 may be used to read a card that carries an identification code that may be uniquely associated with the player so that the gaming unit can differentiate that player from all other players, or so that the gaming unit can differentiate that player as a member of a group of players from all player not a member of the group of players. The electronic gaming machine 200 may also include equipment, such as a keypad 284, an input pad 286 (with optional stylus 287), a port (or antenna) 288 adapted to communicate via a wired or wireless link (infrared or radio frequency link, for example) to a mobile electronic device 290 (such as a personal digital assistant, smart phone or tablet), a camera 292, a scanner 294, a retinal (or iris) scanner 296, fingerprint scanner 297, and/or a microphone 298. The electronic gaming machine 200 may include any one of the devices 258, 284, 286, 288, 290, 292, 294, 296, 297, 298, or the electronic gaming machine 200 may include a combination of some or all of the devices 258, 284, 286, 287, 288, 290, 292, 294, 296, 297, 298.

In operation, a player may identify him or herself to the electronic gaming machine 200 by entering a unique numeric or alpha-numeric code using the key pad 284, for example. Alternatively, the player may use his or her finger or the stylus 287 to sign his or her signature on the input pad 286. As a further alternative, the player may sign his or her signature on the mobile electronic device 290, which signature is then converted to electronic data, and the data is then transferred via the port/antenna 288 to the electronic gaming machine 200. As yet another alternative, the player may sign his or her signature on a piece of paper that is then photographed using the camera 292 or scanned using the scanner 294 (or the bill acceptor 254) to convert the signature into electronic data. As an additional alternative, the player may place one of his or her fingers or his or her hand on the scanner 297, and the scanner 297 may generate an electronic data representation of the fingerprint on one or more of the player's fingers or an electronic data representation of the pattern of the entire hand. Alternatively, the camera 292 may be used to take a picture (live or still) of the player, the picture then being converted into electronic data. As a still further alternative, the player may place his or her eye up to the retinal (or iris) scanner 296, and the retinal (or iris) scanner 296 may generate an electronic data representation corresponding to the pattern of the retina (or iris) of the player. As yet another alternative, the player may speak into the microphone 298, and characteristics of the spoken words (or voiceprint) may be converted into an electronic data representation.

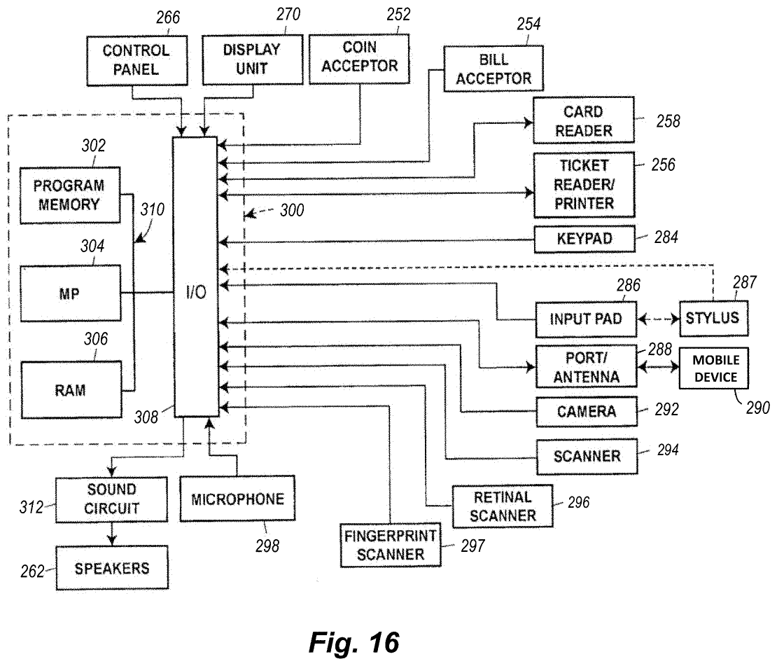

FIG. 16 is a block diagram of a number of components that may be incorporated in the electronic gaming machine 200. Referring to FIG. 16, the electronic gaming machine 200 may include a controller 300 that may comprise a program memory 302, a microcontroller or microprocessor (MP) 304, a random-access memory (RAM) 306 and an input/output (I/O) circuit 308, all of which may be interconnected via an address/data bus 310. It should be appreciated that although only one microprocessor 304 is shown, the controller 300 may include multiple microprocessors 304. Similarly, the memory of the controller 300 may include multiple RAMs 306 and multiple program memories 302. Although the I/O circuit 108 is shown as a single block, it should be appreciated that the I/O circuit 308 may include a number of different types of I/O circuits. The RAM(s) 304 and program memories 302 may be implemented as semiconductor memories, magnetically readable memories, and/or optically readable memories, for example.

FIG. 16 illustrates that the coin acceptor 252, the bill acceptor 254, the ticket reader/printer 256, the card reader 258, the control panel 266, the display unit 270, the keypad 284, the input pad 286 (and optionally the stylus 287), the port/antenna 288, the digital camera 292, the scanner 294, the retinal scanner 296, the fingerprint scanner 297 and the microphone 298 may be operatively coupled to the I/O circuit 308, each of those components being so coupled by either a unidirectional or bidirectional, single-line or multiple-line data link, which may depend on the design of the component that is used. The speaker(s) 262 may be operatively coupled to a sound circuit 312, that may comprise a voice- and sound-synthesis circuit or that may comprise a driver circuit. The sound-generating circuit 312 may be coupled to the I/O circuit 308.

As shown in FIG. 16, the components 252, 254, 256, 258, 266, 270, 284, 286, 287, 288, 292, 294, 296, 297, 298, 312 may be connected to the I/O circuit 308 via a respective direct line or conductor. Different connection schemes could be used. For example, one or more of the components shown in FIG. 15 may be connected to the I/O circuit 308 via a common bus or other data link that is shared by a number of components. Furthermore, some of the components may be directly connected to the microprocessor 304 without passing through the I/O circuit 308.

It will be appreciated that the above described game enhancing elements in FIGS. 5 to 13 are not exhaustive and that other game enhancing elements may be provided. Hence, in some embodiments, the game enhancing element comprises at least one or more of a variety of game enhancing elements, including:
awarding a predetermined number of free plays of the game;
win multipliers that multiply the amount of any win from one of the predetermined winning combinations;
displaying substitute symbols in randomly selected symbol positions that may also award a bonus prize or a multiplier value;
holding the symbols on one or more reels static and displaying substitute symbols;
causing same game symbol to be stacked in a group of symbol positions, typically the group being one or more reels 12a to 12e;
displaying new game symbols in additional game positions 13 added to the array 11;
“reveal” symbols that cause a game symbol to reveal another game symbol; and
“replacement” symbols that cause one or more game symbols to be replaced by other game symbols in the array 11.

These game enhancing symbols do not modify the function or value of the game symbols 10 that appear on the arrays 11, but instead confer bonus prizes, free games or change existing game symbols for other game symbols (such as replacing picture, royal card or symbols belonging to a reel with wild/substitute symbols). Where the function of game symbols 10 have been changed or the game symbols are replaced, then this modification can take effect with the next play of the game instead of applying to the result of the spun array 11. In another embodiment, the game enhancing symbols may indicate the duration in which its game enhancing element is applied, such as a predetermined number of spins or a predetermined time period.

It will be appreciated that in other embodiments, game enhancing elements can also be awarded as a separate aspect of the games 8, 9. The game enhancing elements may further be awarded in addition or as an alternative to the enhanced prizes awarded based on winning combinations of game symbols 10 in the games 8, 9. In a further embodiment, the award of game enhancing elements can be done by way of a sixth reel or the appearance of game enhancing symbols in the reels 12a to 12e. The sixth reel in this case is simply added as an extension to the array 11 and spins either game enhancing symbols or “blank” symbols.

In some embodiments, the game enhancing symbols include “collector”-type game enhancing symbols which award points or tokens. The collection of points or tokens during the base game 8 and/or feature game 9 leads to the trigger of additional prizes or game enhancing symbols, depending on the number of points or tokens that are collected. These additional prizes can include standalone progressive jackpots, bonus prizes and super games, which are enhanced versions of free spins or games where there are greater pay outs or frequency of wins.

In other preferred forms, the game enhancing element can be an enhanced version of the array 11. The enhanced array may provide additional game enhancing symbols that include the award of points or an additional number of free spins of the array 11 (for example, retriggering 5 more free spins). The collection of points awarded by the enhanced array during free spins or game leads to the trigger of additional prizes or game enhancing symbols, depending on the number of points that are collected. These additional prizes can include standalone progressive jackpots, bonus prizes and super games, which are enhanced versions of free spins or games where there are greater pay outs or frequency of wins. In addition, the enhanced array has a different visual representation to the array 11. In addition, the enhanced array may provide game enhancing symbols of greater value and/or frequency compared to the array 11.

Where the game enhancing element comprises the award of a jackpot prize, it can take the form of a standalone progressive jackpot, fixed jackpot, mystery jackpot, symbol driven jackpot and any combination thereof (i.e. a mixture of different types of jackpots). In some embodiments, the jackpots are limited to the feature game 9. In other embodiments, the jackpots are shared by all the games 8 and 9. That is, the jackpots could be won through play of the games 8 and 9.

A progressive jackpot prize takes a portion of each bet (typically a set percentage of each bet) made on the gaming machine and thus the amount of the progressive jackpot incrementally increases as more bets are made on the gaming machine 1. The progressive jackpot is typically awarded when a winning game combination associated with the jackpot occurs in the game played on the gaming machine. In many cases, progressive jackpots are associated with the least probable winning combination and are commonly the highest paying award of the gaming machine. In other cases, a separate trigger event can be used to award the progressive jackpot prize, such as a special jackpot symbol, a trigger event internally generated by the electronic game controller. Alternatively, or additionally, once a certain threshold is met, either a certain amount that has been bet on the gaming machine or the incremented amount of the progressive jackpot, a trigger event is activated in the electronic gaming machine to pay out the progressive jackpot prize. Progressive jackpot prizes also tend to be shared amongst multiple gaming machines so as to increase the amount of the progressive jackpot prize and hence increase player interest in playing one of the electronic gaming machines. In some gaming machines, more than one jackpot or progressive jackpot are offered by the gaming machine or gaming machines linked together.

The jackpot or bonus prizes may also be mystery jackpots rather than symbol driven jackpots. That is, none of the symbols in the game trigger the jackpot; hence the trigger event is a “mystery”. By way of comparison, a standard jackpot is typically symbol driven in that a particular combination of symbols must occur in the game to trigger the standard jackpot.

The trigger event for the mystery jackpot can be one randomly generated by the electronic game controller 4 for each play of the games 8 and 9. One way to implement the random determination of the trigger event is for the electronic game controller 4 to internally generate a random number using the random number generator 4e and check if it is a predetermined number or within a predetermined range of numbers that will initiate the appearance of the trigger symbols. For example, the predetermined range of numbers could be the range of numbers between 1 and 10 and the electronic game controller 4 uses the random number generator 4e to internally generate a random number between 1 and 100. If the generated number is any one of numbers 1 to 10, then this results in the electronic game controller 4 causing the trigger event to occur and award the progressive jackpot prize. It will be appreciated that this manner of determining the jackpot trigger event may also be used to determine whether the feature game 9 is triggered in the base game 8.

Progressive jackpots can be confined to the gaming machine 1 as so called “standalone” progressive jackpots. Alternatively, the jackpot is a wide area or an in-house linked progressive jackpot prize. In other embodiments, one or more the progressive jackpot prizes are configured to be part of a wide area or in-house linked progressive jackpot prize. In other words, the progressive jackpot prizes can be awarded on a group of networked gaming machines in a specified area or a group of specified gaming machines that are linked together for jackpot purposes (usually via a central jackpot controller). The jackpot prizes can also be shared with any other games offered on the same gaming machine 1 (as in multi-game gaming machines).

During play of the games 8 and 9, the electronic game controller 4 will determine whether the trigger event for the jackpot has occurred. In response to the occurrence of the jackpot trigger event(s), the electronic game controller 4 transmits a signal to the video screen 7 to cause the jackpot(s) associated with the jackpot trigger event(s) to be awarded to the player. After the jackpot(s) are awarded, the amounts for any awarded jackpots are reset. The amounts of the jackpots that have been won can be reset either to a predetermined start amount or simply increment upwardly from zero where the won jackpot is a progressive jackpot.

In some embodiments, the in-game trigger event is determined at the end or during the play of the game; i.e. at the end or during a spin of the reels 12. In some embodiments, the in-game trigger event occurs in a preceding play of the game so that the result of the in-game trigger event takes place in a subsequent play of the game, typically the next play of the game after the preceding play but could include a later successive play of the game.

Furthermore, the embodiments of the present disclosure have been described as providing a standard 5×3 array for the base game 8 and the feature game 9. However, it will be appreciated that in other embodiments, the size and shape of the base game array 11 and feature game array may vary as desired. For example, the arrays 11 could take any number of different shapes, such as triangular, circular, square, hexagonal, hemi-spherical or other polygonal shapes. For example, the base game array 11 could comprise a circular array having three rings (equivalent to rows) like a bullseye target segmented into five columns. The feature game array would then expand into additional rings surrounding the initial rings of the base game array 11. Alternatively, the arrays 11 could have an unequal number of rows or columns. For example, the reels 12a, 12b could have three rows, but the reels 12c to 12e could have four rows.

While the preferred embodiments have been described in relation to both a base game 8 and a feature game 9, those skilled in the art will appreciate that the embodiments of the disclosure can readily be applied to the base game alone or a feature game alone. In this instance, the initial trigger event of the combined special symbols 50 and activator symbol 60 takes place in one play of the base game or feature game 9 and triggers the game play of FIGS. 5 to 13 as part of the same game.

In some embodiments, the frequency of the special symbol 50 and/or activator symbol 60 is controlled by choosing different reel strips to display the game symbols 10 in the base game 8. Thus, number and probability of the special symbols 50 and activator symbols 60 appearing on the reels 12 increases as the bet made by the player increases. This means that the frequency of triggering the feature game 9 and awarding bonus prizes increases. This may be instead of or in addition to increasing the amount of the bonus or jackpot prize. There may also be a combination of frequency of the special symbol 50 and/or activator symbol 60 and using different reel strips with different bonus prizes. Other embodiments may use a free spins bonus where the bonus or jackpot prize values are determined by the player's initiating bet multiplier as well as which free spin is being played or by how many special symbols have been collected or accumulated in the free spins so far.

In some embodiments, the number of Mini and Major bonus prize symbols act as multipliers for the Mini and Major bonus prizes. That is, the number of Mini and Major bonus prize symbols multiplies the amount of the Mini and Major bonus prizes won by the player at the conclusion of the feature game. In other words, each Mini and Major bonus prize symbol represents its own Mini and Major bonus prize that can be won multiple times.

In a further variation to the embodiment, additional jackpots are awarded for filling a predetermined number of the game positions with the special symbol. For example, if the player is able to accumulate special symbols in thirteen game positions, then he or she would receive a Maxi progressive jackpot. If the player is able to accumulate special symbols in special game positions, then he or she would receive a Major progressive jackpot. If the player is able to accumulate special symbols in all fifteen game positions of the array, then he or she would receive a Grand progressive jackpot. Thus, more generally, a threshold number of game positions displaying the special symbol results in the award of a bonus prize of higher worth and in some embodiments that threshold number is a majority of the number of the available game positions 13 in the array 11.

Yet another variation to the embodiment, the bonus or jackpot prize values increase as more game positions 13 displaying the special symbol appear on the array 11, thus increasing the value of the potential prizes to be won. Alternatively, the bonus or jackpot prize values increment (with each spin of a free game by the amount of the bet made by the player.

While the same game format is essentially used across the base game 8 and feature game 9, it will be appreciated that the game format may vary across the base and feature games, as well as between base games where more than one game is offered by the same electronic gaming machine 1. For example, one of the games 8 may be a wheel-type game or a four reel game and another of the games may be a standard five reel game. Similarly, the games 8 may each have different game symbols, game rules and pay tables that are unique to each game.

While one embodiment has been described in relation to a base game 8 and a feature game 9, it will be appreciated that the present disclosure could include one or more additional feature games that are triggered by specific trigger symbols appearing in the feature game 9. Also, the additional feature games may also have trigger symbols that trigger further feature games in a cascading fashion. These additional and further feature games could have the same game play elements as the feature game 9 or be different feature games entirely.

In other embodiments, the base game 8 and the feature game 9 need not be displayed alternately on a single video screen 7. Instead, they may be displayed on the same video screen 7, with the base game 8 shown in the lower playing area 7a and the feature game 9 shown in the upper display area of the video screen 7. Alternatively, the base game 8 and the feature game 9 are shown on separate video screens, with the base game 8 shown in a lower video screen corresponding to the lower playing area 7a and the feature game 9 shown in an upper video screen corresponding to the upper display area. Also, the order can be reversed, with the lower playing area 7a or video screen showing the feature game 9 and the upper video screen or upper playing area of a single video display screen 7 showing the base game 8.

In another embodiment, the video screen 7 is a touch screen for use in addition to the player-actuatable buttons 6 so as to enable the player to select the bet level (such as bet denominations or bet per pay line 14) as well as other various features, such as making monetary bets for the game, initiating play of any base and feature games played and responding to any messages or requests issued on the gaming machine 1 by the electronic game controller 4. In this case, the player may control when the reels 12 start spinning and stop spinning, either individually or collectively, by simply touching the reels 12. Control over spinning of the reels 12 can also be implemented through the buttons 6 on the console 3. This increases player interaction and provide the player with an opportunity to guess when a particular game symbol 10 may appear in the reels 12.

In some embodiments, the electronic controller causes the display of the feature game 9 and the base game 8 during play of the base game, the feature game being inactive until triggered. In this embodiment, the change in the feature game 9 from being inactive to active may be indicated on the display. This indication may be visual, aural or a combination of both.

In some embodiments, the gaming machine comprises an input device for receiving commands from the player to play the game, wherein the input device comprises one or more buttons in electronic communication with the electronic controller to transmit the player commands to the electronic controller. In other embodiments, the buttons comprise physical buttons on the gaming machine, virtual buttons on the display or a combination of both.

In some embodiments, the input device comprises one or more buttons on the housing, the buttons being in electronic communication with the electronic controller. In other embodiments, the buttons are arranged on a console of the housing. Alternatively or additionally, the input device comprises a touch sensitive surface on the display for receiving commands from the player, the touch sensitive surface being in electronic communication with the electronic game controller to transmit the player commands to the electronic controller.

In some embodiments, the gaming machine comprises a value transfer mechanism for receiving value from the player to make a bet and initiate a play of the game. In other embodiments, the value transfer mechanism also pays the prizes to the player using value in an amount equal to an awarded prize. It is further preferred that the housing comprises the value transfer mechanism. In one embodiment, the value transfer mechanism comprises one or more vending slots for paying and/or receiving value. In other embodiments, the value transfer mechanism comprises a value input/value output device. In further embodiments, the value transfer mechanism comprises a coin slot or acceptor, a paper currency acceptor, a ticket reader and/or printer or a card reader and/or writer.

Preferably, the game positions are organised into groups. More preferably, the groups comprise reels in the array. In some embodiments, the array comprises five reels. In other embodiments, the reels each comprise three game positions.

Preferably, the one or more of the configurations of the randomly selected game symbols are arranged along a pay line associated with a game outcome. In some embodiments, a play of the game comprises a plurality of randomly selected game symbols arranged in a plurality of reels, one or more of the configurations of the randomly selected game symbols arranged along a pay line being associated with a game outcome, the game outcome being associated with a value award payable to a player.

In some embodiments, the controller comprises an electronic controller coupled to the display. In other embodiments, the controller comprises an electronic controller coupled to at least one electronic video display.

In some embodiments, each the game position 13 comprises a reel separate to the other game positions. That is, each game or symbol position 13 comprises its own individual reel and three of the reels are grouped into columns 12a to 12e of reels. That is, each symbol position 13 has its own individual reel strip of game symbols.

In other embodiments, the gaming machine 1 also offers the player the opportunity to play in community games against other players in so-called tournament games, or even in player versus player games. This is typically implemented by electronically linking several gaming machines 1 in a group within a gaming venue. The player versus player or tournament game can be played simultaneously by the players or can be staggered, with some players playing at one time and some players playing at another time in the same game. In this situation, the player versus player or tournament game comprises the award of an additional bonus prize in addition to the jackpot prizes in the selected available jackpot set.

In some embodiments, the base game and the feature game each comprises an array of rows and columns of the predetermined game positions, and the base game array is different in size and/or dimensions to the feature game array. In other embodiments, the feature game array is greater in size than the base game array. In one preferred form, the base array comprises three rows and five columns and the feature game array comprises either more than three rows or more than five columns. In a further preferred form, the feature game array is an extended base game array.

In some embodiments, a feature game trigger event occurs in the base game to trigger the feature game. In one embodiment, the feature game trigger event comprises a random event determined by the electronic game controller at the start of play of the feature game. In another embodiment, the feature game trigger event comprises the appearance of at least one trigger symbol in the base game array. In another alternative, the feature game trigger event comprises an in-game event during play of the base game.

In some embodiments, the array (including the base game array and/or the feature game array) take any one of a circular, triangular, oval, semi-circular, hexagonal, pentagonal, octagonal, non-rectangular or polygonal shape. In one preferred form, the wheels and the enhanced wheels arrays take the form of partially shown circular wheels.

In some embodiments, the player selectively starts and/or stops play of the base game array and/or the feature game array. This may achieved by using either a physical button 6 on the console 3 or a touch sensitive surface on the lower screen 7a acting as a virtual button.

In some embodiments, the game symbols may be used to play a slots-type game. In other embodiments, the game symbols may be used to play a poker-type game. In further embodiments, the game symbols may be used to play a bingo or keno-type game

The electronic controller 4 may randomly select the game symbols that appear in or on the array (e.g., using the random number generator 4e), each column of the array corresponding to a reel in a mechanical or electromechanical display, and provide an award based on the randomly selected configuration. Alternatively, the machine 1 (or a server associated with the machine 1) may select an outcome from a pool of outcomes, and the machine 1 may display a configuration of symbols in accordance with that outcome, and provide an award in accordance with the outcome.

It will be appreciated that while the preferred embodiments have been described in relation to an industry standard electronic gaming machine, the present disclosure can be readily applied to other types of electronic gaming machines, including a personal computer (standing alone or connected to a communications network, LAN or WAN), mobile electronic devices (such as handheld or portable electronic devices like tablets and smart phones) and other electronic devices capable of displaying a game. In the case of mobile electronic device, in one arrangement it may permit the player to make bets using “virtual” credits that represent a monetary value, but do not require the player to make a monetary transaction. Instead, the present disclosure may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the present disclosure is implemented on a personal computer (PC) connected to the internet (wirelessly or not). In one example of the implementation, the PC would access an online casino over the internet to play the game of the present disclosure or the game of the present disclosure would be part of a social networking website. It is also contemplated that the player could also make regular payments to subscribe to continue playing the game on the mobile electronic device, PC or other electronic device.

In an alternative embodiment, the gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the present disclosure includes a computer programme configured to perform the present disclosure. In this way the present disclosure can be implemented in various ways on a gaming machine. In a further aspect, the present disclosure includes a gaming system configured comprising a central processing unit (such as a computer or computational processor) configured for communication with a gaming machine to perform the present disclosure. In a yet another aspect, the present disclosure includes a non-transitory computer readable or carrier medium carrying computer executable code that, when executed on a central processing unit configured for communication with a gaming machine, causes the central processing unit to perform the present disclosure. In this case, the non-transitory carrier medium includes an external hard drive, a memory device, including a memory card, smart card, a radio frequency identification (RFID) device, USB key, magnetic card or other electronic storage device.

While the illustrated embodiments include an electronic display on which the array of game positions is displayed, it will be recognized that the disclosed embodiments could instead incorporate mechanical or electro-mechanical reels to define the array of game positions. In fact, to the extent that the game positions, game symbols or operation of the gaming machine described herein would require a modification of such mechanical or electro-mechanical reels, it will be recognized that the embodiment represents a change in the structure or operation of a machine, rather than simply a variation in the rules of playing a game. In addition or in the alternative, the variation in the game positions, game symbols or operation of the gaming machine described herein may be viewed as analogous to a method for utilizing a new game apparatus (like a new deck of cards), rather than simply as a new set of rules in and of themselves.

It will further be appreciated that any of the features in the preferred embodiments of the present disclosure can be combined together and are not necessarily applied in isolation from each other. For example, the feature of the player being able to selectively starting or stopping spinning of the reels 12 and the feature of providing separate video screens for the lower playing area 7a and upper display area can be combined into a single gaming machine 1. Similar combinations of two or more features from the above described embodiments or embodiments of the present disclosure can be readily made by one skilled in the art.

By providing a combination of randomly awarded game enhancing elements and predefined game enhancing elements within the same game, the embodiments of the present disclosure increase the chance of winning additional prizes and the amount of those additional prizes. The embodiments of the present disclosure also add greater value to a player in terms of the probability of winning a prize and providing greater variety in game play, especially compared to a conventional gaming machine that only has one set of reels and a single feature game. All these advantages of the present disclosure result in the player being more likely to retain interest in continuing to play the same gaming machine due to the variation in game play on the gaming machine. Furthermore, since the electronic controller controls operation of the gaming machine, the present disclosure can be readily implemented to existing gaming machines, including EGMs, electro-mechanical or purely mechanical gaming machines as well as other gaming systems. In all these respects, the present disclosure represents a practical and commercially significant improvement over the prior art.

In conclusion, although the preceding text sets forth a detailed description of different embodiments of the present disclosure, it should be understood that the legal scope of the present disclosure is defined by the words of the claims set forth at the end of this patent. The detailed description is to be construed as exemplary only and does not describe every possible embodiment of the present disclosure since describing every possible embodiment would be impractical, if not impossible. Numerous alternative embodiments could be implemented, using either current technology or technology developed after the filing date of this patent, which would still fall within the scope of the claims defining the present disclosure.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

1. A gaming machine comprising:
a display for displaying a game, wherein the game comprises randomly selected game symbols displayed in an array of game positions, and where predetermined winning combinations of the randomly selected game symbols in the game award prizes to a player;
a game controller for controlling the display of the game symbols on the display, the game controller comprising a processor for executing program instructions stored on a memory to operate the game;
a random number generator to randomly select the game symbols;
a metering module for monitoring the credits available to play the gaming machine and the amount of any wins made by the player;
a value transfer mechanism for receiving value from the player, wherein the value transfer mechanism comprises at least one of a coin slot or acceptor, a paper currency acceptor, a ticket reader and/or printer or a card reader and/or writer; and
a plurality of buttons in communication with the game controller to receive and transmit player commands to the game controller to play the game;
wherein the game controller is in communication with the value transfer mechanism and the metering module such that when a threshold amount of value has been received from the value transfer mechanism, the game controller initiates a play of the game;
wherein the game controller is configured to:
randomly select game symbols in a first play of the game, wherein the game symbols are selected from a set of game symbols, including a special symbol and an activator symbol;
associate a game enhancing element with each selected special symbol;
display the randomly selected game symbols in the game positions;
in response to a predetermined number of special symbols and at least one activator symbol being displayed in the first play, for one or more subsequent plays of the game, the game controller is configured to:
display the special symbols and the at least one activator symbol in the same game positions;
randomly select game symbols from the set of game symbols;
display the randomly selected game symbols in game positions not occupied by the special symbols or the at least one activator symbol;
determine if additional special symbols or activator symbols are displayed in the array;
award the game enhancing elements associated with the displayed special symbols; and
display the additional special symbols and activator symbols in the same game positions in the next play of the game.

2. The gaming machine of claim 1, wherein the game enhancing element is randomly associated with each special symbol.

3. The gaming machine of claim 1, wherein the game enhancing element associated with one or more special symbols comprises a credit prize or a jackpot prize.

4. The gaming machine of claim 3, wherein the amount of the credit prize or jackpot prize is randomly selected for each special symbol.

5. The gaming machine of claim 1, wherein the game enhancing element is immediately awarded to the player during the game.

6. The gaming machine of claim 1, wherein the game enhancing element is immediately awarded to the player at the end of the game.

7. The gaming machine of claim 1, wherein the activator symbol is associated with a multiplier value that multiplies the amount of prizes awarded in the game.

8. The gaming machine of claim 1, wherein the number of activator symbols are counted at the end of the game and the amount of a prize awarded is multiplied by the number of activator symbols counted.

9. The gaming machine of claim 1, wherein the activator symbol causes the game enhancing elements associated with the displayed special symbols to be awarded again in the same play.

10. The gaming machine of claim 9, wherein the game enhancing elements associated with the displayed special symbols are awarded again in the same play for each activator symbol displayed in the array.

11. The gaming machine of claim 1, wherein a predetermined number of activator symbols appearing in the array causes the game controller to reset the number of plays remaining in the game.

12. The gaming machine of claim 1, wherein a predetermined number of trigger symbols appearing in the array causes the game controller to reset the number of plays remaining in the game, the trigger symbols being associated with a credit prize.

13. A gaming machine comprising:
a display for displaying a first game, wherein the first game comprises randomly selected game symbols displayed in an array of game positions, and where predetermined winning combinations of the randomly selected game symbols in the game award prizes to a player;
a game controller for controlling the display of the game symbols on the display, the game controller comprising a processor for executing program instructions stored on a memory to operate the game;
a random number generator to randomly select the game symbols;
a metering module for monitoring the credits available to play the gaming machine and the amount of any wins made by the player;
a value transfer mechanism for receiving value from the player, wherein the value transfer mechanism comprises at least one of a coin slot or acceptor, a paper currency acceptor, a ticket reader and/or printer or a card reader and/or writer; and
a plurality of buttons in communication with the game controller to receive and transmit player commands to the game controller to play the game;
wherein the game controller is in communication with the value transfer mechanism and the metering module such that when a threshold amount of value has been received from the value transfer mechanism, the game controller initiates a play of the first game;
wherein the game controller is configured to:
randomly select game symbols in the play of the first game, wherein the game symbols are selected from a set of game symbols, including a special symbol and an activator symbol;
associate a game enhancing element with each selected special symbol;
display the randomly selected game symbols in the game positions;
in response to a predetermined number of special symbols and at least one activator symbol being displayed in the play of the first game, triggering a second game, wherein for each play of the second game, the game controller is configured to:
display the special symbols and the at least one activator symbol in the same game positions;
randomly select game symbols from the set of game symbols;
display the randomly selected game symbols in game positions not occupied by the special symbols or the at least one activator symbol;
determine if additional special symbols or activator symbols are displayed in the array;
award the game enhancing elements associated with the displayed special symbols; and
display the additional special symbols and activator symbols in the same game positions in the next play of the second game.

14. The gaming machine of claim 13, wherein the game enhancing element is randomly associated with each special symbol.

15. The gaming machine of claim 13, wherein the game enhancing element associated with one or more special symbols comprises a credit prize or a jackpot prize.

16. The gaming machine of claim 15, wherein the amount of the credit prize or jackpot prize is randomly selected for each special symbol.

17. The gaming machine of claim 13, wherein the game enhancing element is immediately awarded to the player during the game.

18. The gaming machine of claim 13, wherein the game enhancing element is immediately awarded to the player at the end of the game.

19. The gaming machine of claim 13, wherein the activator symbol is associated with a multiplier value that multiplies the amount of prizes awarded in the game.

20. The gaming machine of claim 13, wherein the number of activator symbols are counted at the end of the game and the amount of a prize awarded is multiplied by the number of activator symbols counted.

21. The gaming machine of claim 13, wherein the activator symbol causes the game enhancing elements associated with the displayed special symbols to be awarded again in the same play.

22. The gaming machine of claim 21, wherein the game enhancing elements associated with the displayed special symbols are awarded again in the same play for each activator symbol displayed in the array.

23. The gaming machine of claim 13, wherein a predetermined number of activator symbols appearing in the array causes the game controller to reset the number of plays remaining in the game.

24. The gaming machine of claim 13, wherein a predetermined number of trigger symbols appearing in the array causes the game controller to reset the number of plays remaining in the game, the trigger symbols being associated with a credit prize.
